(19) United States
(12) Patent Application Publication
(10) Pub. No.: US 2024/0306024 A1
(43) Pub. Date: Sep. 12, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/263,988

(22) PCT Filed: Feb. 2, 2022
(86) PCT No.: PCT/JP2022/004065

§ 371 Date: Aug. 2, 2023

(30) Foreign Application Priority Data
Feb. 4, 2021 (JP) 2021-016811

(51) Int. Cl. H04W 24/10; H04L 5/00

(52) U.S. Cl. CPC H04W 24/10; H04L 5/0035

(57) ABSTRACT

Measurement and report of CSI for a multi panel/TRP is appropriately performed. A terminal according to one aspect of the present disclosure includes a receiving section that receives configuration information regarding a resource for first channel measurement related to a resource group for first channel measurement and a resource for second channel measurement related to a resource group for second channel measurement, and a control section that determines whether or not to use the resource for first channel measurement and the resource for second channel measurement for measurement for a plurality of transmission/reception points.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

In existing LTE systems (for example, 3GPP Rel. 8 to Rel. 14), a user terminal (User Equipment (UE)) transmits uplink control information (UCI) by using at least one of a UL data channel (for example, a Physical Uplink Shared Channel (PUSCH)) and a UL control channel (for example, a Physical Uplink Control Channel (PUCCH)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In NR, a scheme in which one or a plurality of transmission/reception points (TRPs) (multi TRP) perform DL transmission (for example, PDSCH transmission) to a user terminal (User Equipment (UE)) by using one or a plurality of panels (multi panel) has been under study.

However, in existing NR specifications such as those of Rel. 15, the multi panel/TRP is not taken into consideration, and accordingly how to perform measurement and report of CSI when the multi panel/TRP is used has not yet been clarified. Unless measurement and report of the CSI is appropriately performed, system performance may be deteriorated, e.g., throughput may be reduced.

In view of this, the present disclosure has one object to provide a terminal, a radio communication method, and a base station that appropriately perform measurement and report of CSI for a multi panel/TRP.

### Solution to Problem

A terminal according to one aspect of the present disclosure includes a receiving section that receives configuration information regarding a resource for first channel measurement related to a resource group for first channel measurement and a resource for second channel measurement related to a resource group for second channel measurement, and a control section that determines whether or not to use the resource for first channel measurement and the resource for second channel measurement for measurement for a plurality of transmission/reception points.

### Advantageous Effects of Invention

According to one aspect of the present disclosure, measurement and report of CSI for a multi panel/TRP can be appropriately performed.

### BRIEF DESCRIPTION OF DRAWINGS

FIG. 1 is a diagram to show CSI report configuration (CSI-ReportConfig) of 3GPP Rel. 16.

FIG. 2 is a diagram to show a first example of the CSI report configuration related to implicit IMR configuration.

FIG. 3 is a diagram to show a second example of the CSI report configuration related to the implicit IMR configuration.

FIG. 4 is a diagram to show a relationship between CMRs and CSI-IMs in option 1-1 of a first embodiment.

FIG. 5 is a diagram to show a relationship between CSI pairs, ZP-IMRs, and NZP-IMRs in option 1-1 of the first embodiment.

FIG. 6 is a diagram to show a relationship between the CMRs and the CSI-IMs in option 1-2 of the first embodiment.

FIG. 7 is a diagram to show a relationship between the CSI pairs, the ZP-IMRs, and the NZP-IMRs in option 1-2 of the first embodiment.

FIG. 8 is a diagram to show a relationship between the CMRs and the CSI-IMs in option 1-3 of the first embodiment.

FIG. 9 is a diagram to show a relationship between the CSI pairs, the ZP-IMRs, and the NZP-IMRs in option 1-3 of the first embodiment.

FIG. 10 is a diagram to show a relationship between the CMRs and the CSI-IMs in option 1-4 of the first embodiment.

FIG. 11 is a diagram to show a relationship between the CSI pairs, the ZP-IMRs, and the NZP-IMRs in option 1-4 of the first embodiment.

FIG. 12 is a diagram to show a relationship between the CMRs, the CSI-IMs, and the NZP-IMs in option 2-1 of a second embodiment.

FIG. 13 is a diagram to show a relationship between the CSI pairs, the ZP-IMRs, and the NZP-IMRs in option 2-1 of the second embodiment.

FIG. 14 is a diagram to show a relationship between the CMRs and the CSI-IMs in option 2-2 of the second embodiment.

FIG. 15 is a diagram to show a relationship between the CSI pairs, the ZP-IMRs, and the NZP-IMRs in option 2-2 of the second embodiment.

FIG. 16 is a diagram to show a relationship between the CMRs and the CSI-IMs in option 2-3 of the second embodiment.

FIG. 17 is a diagram to show a relationship between the CSI pairs, the ZP-IMRs, and the NZP-IMRs in option 2-3 of the second embodiment.

FIG. 18 is a diagram to show a relationship between the CMRs and the CSI-IMs in option 2-4 of the second embodiment.

FIG. 19 is a diagram to show a relationship between the CSI pairs, the ZP-IMRs, and the NZP-IMRs in option 2-4 of the second embodiment.

FIG. 20 is a diagram to show a configuration example of the CMRs in option 3-1-1 of a third embodiment.

FIG. 21 is a diagram to show a configuration example of the CMRs in option 3-1-2 of the third embodiment.

FIG. 22 is a diagram to show a configuration example of the CMRs/CSI-IMs in option 3-2-1 of the third embodiment.

FIG. 23 is a diagram to show a configuration example of the CMRs/CSI-IMs in option 3-2-2 of the third embodiment.

FIG. 24 is a diagram to show a first configuration example of the CMRs in option 4-1-1 of a fourth embodiment.

FIG. 25 is a diagram to show a second configuration example of the CMRs in option 4-1-1 of the fourth embodiment.

FIG. 26 is a diagram to show a first configuration example of the CMRs in option 4-1-2 of the fourth embodiment.

FIG. 27 is a diagram to show a second configuration example of the CMRs in option 4-1-2 of the fourth embodiment.

FIG. 28 is a diagram to show a configuration example of the CMRs/CSI-IMs in option 4-2-1 of the fourth embodiment.

FIG. 29 is a diagram to show a configuration example of the CMRs/CSI-IMs in option 4-2-2 of the fourth embodiment.

FIGS. 30A and 30B are each a diagram to show an example of a problem in measurement of beam pairs.

FIGS. 31A and 31B are each a diagram to show a configuration example of the CMRs in option 6-1-1 of a sixth embodiment.

FIG. 32 is a diagram to show a configuration example of the CMRs in option 6-2 of the sixth embodiment.

FIGS. 33A and 33B are each a diagram to show an example of repetition of the CMRs in option 6-2 of the sixth embodiment.

FIGS. 34A and 34B are each a diagram to show a configuration example of the CMRs in option 7-2 of a seventh embodiment.

FIG. 35 is a diagram to show an example of a schematic structure of a radio communication system according to one embodiment.

FIG. 36 is a diagram to show an example of a structure of a base station according to one embodiment.

FIG. 37 is a diagram to show an example of a structure of a user terminal according to one embodiment.

FIG. 38 is a diagram to show an example of a hardware structure of the base station and the user terminal according to one embodiment.

### DESCRIPTION OF EMBODIMENTS

### (CSI Report (or Reporting))

In Rel-15 NR, a terminal (also referred to as a user terminal, a User Equipment (UE), or the like) generates (also described as determines, calculates, estimates, measures, or the like) channel state information (CSI), based on a reference signal (RS) (or a resource for the RS), and transmits (also described as reports, feeds back, or the like) the generated CSI to a network (for example, a base station). The CSI may be, for example, transmitted to the base station by using an uplink control channel (for example, a Physical Uplink Control Channel (PUCCH)) or an uplink shared channel (for example, a Physical Uplink Shared Channel (PUSCH)).

The RS used for generation of the CSI may be, for example, at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information (report configuration information) related to a CSI report, and control the CSI report, based on the report configuration information. The report configuration information may be, for example, a radio resource control (RRC) information element (IE) “CSI-ReportConfig”. Note that, in the present disclosure, the RRC IE may be interchangeably interpreted as an RRC parameter, a higher layer parameter, or the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent CSI report (Semi-Persistent CSI (SP-CSI)) report.

The report quantity information may indicate at least one combination of the CSI parameters (for example, the CRI, the RI, the PMI, the COI, the LI, the L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate frequency granularity of the CSI report. The frequency granularity may include, for example, a wideband and a subband. The wideband is an entire CSI reporting band. The wideband may be, for example, an entire certain carrier (component carrier (CC), cell, serving cell), or may be an entire bandwidth part (BWP) in a certain carrier. The wideband may be interpreted as a CSI reporting band, an entire CSI reporting band, or the like.

The subband is a part of the wideband, and may include one or more resource blocks (RBs) (or physical resource blocks (PRBs)). The size of the subband may be determined depending on the size of the BWP (number of PRBs).

The frequency domain information may indicate which of the PMI of the wideband or of the subband is to be reported (the frequency domain information may include, for example, an RRC IE “pmi-FormatIndicator” used for determining any of a wideband PMI report and a subband PMI report). The UE may determine frequency granularity of the CSI report (in other words, any of the wideband PMI report and the subband PMI report), based on at least one of the report quantity information and the frequency domain information.

When the wideband PMI report is configured (determined), one wideband PMI may be reported for the entire CSI reporting band. In contrast, when the subband PMI report is configured, a single wideband indication i₁ is reported for the entire CSI reporting band, and subband indication (one subband indication) i₂ of each of one or more subbands (for example, the subband indication of each subband) in the entire CSI report may be reported.

The UE performs channel estimation by using a received RS, and estimates a channel matrix H. The UE feeds back an index (PMI) that is determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

In the space domain, the CSI report may include one or more types of CSI. For example, the CSI may include at least one of a first type (type 1 CSI) that is used for selection of a single beam and a second type (type 2 CSI) that is used for selection of a multi beam. The single beam may be interpreted as a single layer, and the multi beam may be interpreted as a plurality of beams. The type 1 CSI may not assume multi user multiple input multiple output (MIMO), and the type 2 CSI may assume multi user MIMO.

The codebook may include a codebook for the type 1 CSI (also referred to as a type 1 codebook or the like) and a codebook for the type 2 CSI (also referred to as a type 2 codebook or the like). The type 1 CSI may include type 1 single panel CSI and type 1 multi panel CSI, and different codebooks (type 1 single panel codebook, type 1 multi panel codebook) may be respectively defined.

In the present disclosure, “type 1” and “type I” may be interchangeably interpreted as each other. In the present disclosure, “type 2” and “type II” may be interchangeably interpreted as each other.

Uplink control information (UCI) types may include at least one of a Hybrid Automatic Repeat reQuest ACKnowledgement (HARQ-ACK), a scheduling request (SR), and CSI. The UCI may be carried on the PUCCH, or may be carried on the PUSCH.

In Rel-15 NR, the UCI can include one CSI part for wideband PMI feedback. CSI report #n includes PMI wideband information if being reported.

In Rel-15 NR, the UCI can include two CSI parts for subband PMI feedback. CSI part 1 includes wideband PMI information. CSI part 2 includes one piece of wideband PMI information and some pieces of subband PMI information. The CSI part 1 and the CSI part 2 are separately coded.

In Rel-15 NR, the UE is configured with report setting of N (N≥1) CSI report configurations and resource setting of M (M≥1) CSI resource configurations by a higher layer. For example, the CSI report configuration (CSI-ReportConfig) includes resource setting for channel measurement (resourcesForChannelMeasurement), CSI-IM resource setting for interference (csi-IM-ResourceForInterference), NZP-CSI-RS setting for interference (nzp-CSI-RS-ResourceFor Interference), report quantity (reportQuantity), and the like. Each of the resource setting for channel measurement, the CSI-IM resource setting for interference, and the NZP-CSI-RS setting for interference is associated with the CSI resource configuration (CSI-ResourceConfig, CSI-ResourceConfigId). The CSI resource configuration includes a list of CSI-RS resource sets (csi-RS-ResourceSetList, for example, an NZP-CSI-RS resource set or a CSI-IM resource set).

For both of FR1 and FR2, in order to enable more dynamic channel/interference hypotheses for NCJT, evaluation and definition of the CSI report for transmission of at least one of the multi TRP and the multi panel of the DL have been under study.

### (Multi TRP)

In NR, a scheme in which one or a plurality of transmission/reception points (TRPs) (multi TRP (MTRP)) perform DL transmission to the UE by using one or a plurality of panels (multi panel) has been under study. In addition, a scheme in which the UE performs UL transmission to one or a plurality of TRPs by using one or a plurality of panels has been under study.

Note that the plurality of TRPs may correspond to the same cell identifier (ID), or may correspond to different cell IDs. The cell ID may be a physical cell ID, or may be a virtual cell ID.

The multi TRP (TRPs #1 and #2) are connected with an ideal/non-ideal backhaul, and information, data, and the like may be exchanged therebetween. Different code words (CWs) and different layers may be transmitted from each TRP of the multi TRP. As one mode of multi TRP transmission, non-coherent joint transmission (NCJT) may be used.

In NCJT, for example, TRP1 performs modulation mapping of a first code word and performs layer mapping so as to transmit a first PDSCH by using first precoding for a first number of layers (for example, two layers). TRP2 performs modulation mapping of a second code word and performs layer mapping so as to transmit a second PDSCH by using second precoding for a second number of layers (for example, two layers).

Note that it may be defined that a plurality of PDSCHs (multi PDSCH) subjected to NCJT partially or entirely overlap in at least one of time and frequency domains. In other words, at least one of the time and frequency resources of the first PDSCH from the first TRP and the second PDSCH from the second TRP may overlap.

It may be assumed that these first PDSCH and second PDSCH are not in a relationship of quasi-co-location (QCL) (not quasi-co-located). Reception of the multi PDSCH may be interpreted as simultaneous reception of PDSCHs that are not of a certain QCL type (for example, QCL type D).

A plurality of PDSCHs (which may be referred to as multi PDSCH (multiple PDSCHs)) from the multi TRP may be scheduled using one DCI (single DCI (S-DCI), single PDCCH) (single master mode). One DCI may be transmitted from one TRP of the multi TRP. A plurality of PDSCHs from the multi TRP may be respectively scheduled using a plurality of DCIs (multi DCI (M-DCI), multi PDCCH (multiple PDCCH)) (multi master mode). The plurality of DCIs may be respectively transmitted from the multi TRP. The UE may assume to transmit, to different TRPs, different CSI reports related to the respective TRPs. Such CSI feedback may be referred to as separate feedback, separate CSI feedback, or the like. In the present disclosure, “separate” may be interchangeably interpreted as “independent”.

Note that the CSI feedback in which the CSI report related to both of the TRPs is transmitted to one TRP may be used. Such CSI feedback may be referred to as joint feedback, joint CSI feedback, or the like.

For example, in a case of the separate feedback, the UE is configured to transmit a CSI report for TRP #1 to TRP #1 by using a certain PUCCH (PUCCH1) and transmit a CSI report for TRP #2 to TRP #2 by using another PUCCH (PUCCH2). In a case of the joint feedback, the UE transmits the CSI report for TRP #1 and the CSI report for TRP #2 to TRP #1 or #2.

According to the multi TRP scenario as described above, more flexible transmission control using a channel having satisfactory quality can be performed.

For the multi TRP transmission, CSIs for a plurality of different TRPs are usually different, and thus how to perform measurement and report of the CSIs for a plurality of different TRPs has not yet been clarified. For one TRP, the channel/interference hypotheses vary depending on determination (traffic) of transmission of neighboring TRPs.

For example, a CSI report for the separate feedback (which may be referred to as a separate CSI report) may be configured using one CSI report configuration (CSI-ReportConfig) associated with one TRP.

The CSI report configuration may correspond to one interference hypothesis regarding one TRP (in other words, different CSI report configurations may be used for each TRP or for each interference hypothesis). The CSI report configuration may correspond to a plurality of interference hypotheses regarding one TRP (in other words, different CSI report configurations may be used for each TRP, and one CSI report configuration may be associated with a plurality of interference hypotheses regarding a certain TRP).

For example, a CSI report for the joint feedback (which may be referred to as a joint CSI report) may be configured using one CSI report configuration (CSI-ReportConfig) associated with a plurality of TRPs.

The CSI report configuration may correspond to one interference hypothesis regarding each of a plurality of TRPs (in other words, a CSI report including a CSI of interference hypothesis #1 regarding TRP #1 and a CSI of interference hypothesis #1 regarding TRP #2 may be configured using a certain CSI report configuration, and a CSI report including a CSI of interference hypothesis #2 regarding TRP #1 and a CSI of interference hypothesis #1 regarding TRP #2 may be configured using another CSI report configuration). The CSI report configuration may correspond to a plurality of interference hypotheses regarding each of a plurality of TRPs (in other words, a CSI report including two CSIs of interference hypotheses #1 and #2 regarding TRP #1 and two CSIs of interference hypotheses #3 and #4 regarding TRP #2 may be configured using one CSI report configuration).

Note that the CSI report configuration for the joint CSI report may include a resource configuration for each TRP (at least one of the resource setting for channel measurement, the CSI-IM resource setting for interference, and the NZP-CSI-RS setting for interference). The resource configuration of a certain TRP may be configured being included in a resource configuration group (resource setting group).

Note that the resource configuration group may be identified with a configured resource configuration group index. The resource configuration group may be interchangeably interpreted as a report group. The resource configuration group index (which may be simply referred to as a group index) may indicate a CSI report related to a TRP (to which TRP a certain CSI report (or CSI report configuration, CSI resource configuration, CSI-RS resource set, CSI-RS resource, TCI state, QCL, or the like) corresponds). For example, group index #i may correspond to TRP #i.

The CSI report configuration for the separate CSI report may be referred to as a separate CSI report configuration, a separate CSI configuration, or the like. The CSI report configuration for the joint CSI report may be referred to as a joint CSI report configuration, a joint CSI configuration, or the like.

Regarding the MTRP, it is preferable that single TRP (STRP) transmission and MTRP transmission be dynamically switched depending on a channel state or the like. For the sake thereof, the following CSIs are required:
CSI (hereinafter also referred to as CSI A) for the TRP1 (first TRP) assuming STRP transmission,
CSI (hereinafter also referred to as CSI B) for the TRP2 (second TRP) assuming STRP transmission,
CSI (hereinafter also referred to as CSI C) for the TRP1 with inter-TRP/beam interference from the TRP2 being taken into consideration, assuming NCJT transmission of the MTRP,
CSI (hereinafter also referred to as CSI D) for the TRP2 with inter-TRP/beam interference from the TRP1 being taken into consideration, assuming NCJT transmission of the MTRP.

### <CMR and IMR>

When interference measurement is executed using the CSI-IM, each CSI-RS resource in channel measurement is associated with the CSI-IM resource for each resource in accordance with ordering of the CSI-RS resources and the CSI-IM resources in a corresponding resource set. The number of CSI-RS resources for channel measurement may be the same as the number of CSI-IM resources.

In a case of ZP-CSI-RS based interference measurement, the CSI-RS resources for channel measurement (CMR) and the CSI-RS resources for interference measurement (IMR) are associated with each other for each resource. In other words, this is one-to-one mapping.

When Kₛ (>1) resources are configured in a corresponding resource set for channel measurement, the UE needs to derive CSI parameters other than the CRI conditioned upon reported CRI. CRI k (k≥0) corresponds to a (k+1)-th configured entry of associated nzp-CSI-RSResource in corresponding nzp-CSI-RS-ResourceSet for channel measurement, and corresponds to a (k+1)-th configured entry of associated csi-IM-Resource in corresponding csi-IM-ResourceSet (if configured).

In other words, CRI k (k≥0) corresponds to a (k+1)-th configured CMR and a (k+1)-th configured IMR.

### <Aperiodic CSI>

In a case of the aperiodic CSI, each trigger state configured using a higher layer parameter “CSI-AperiodicTriggerState” is associated with one or a plurality of CSI report configurations (CSI-ReportConfig). Each CSI report configuration is linked to periodic, semi-persistent, or aperiodic resource setting.

When one resource configuration is configured, the resource configuration (given by a higher layer parameter resourcesForChannelMeasurement) is for channel measurement for calculation of the L1-RSRP or the L1-SINR.

When two resource configurations are configured, a first resource configuration (given by the higher layer parameter resourcesForChannelMeasurement) is for channel measurement, and a second resource configuration (given by a higher layer parameter csi-IM-ResourcesForInterference or nzp-CSI-RS-ResourcesForInterference) is for interference measurement executed using the CSI-IM or the NZP-CSI-RS.

When three resource configurations are configured, a first resource configuration (given by the higher layer parameter resourcesForChannelMeasurement) is for channel measurement, a second resource configuration (given by the higher layer parameter csi-IM-ResourcesForInterference) is for CSI-IM based interference measurement, and a third resource configuration (given by the higher layer parameter nzp-CSI-RS-ResourcesForInterference) is for NZP-CSI-RS based interference measurement.

When the aperiodic CSI is applied, NR may support interference measurement based on only the ZP-CSI-RS, only the NZP-CSI-RS, and the ZP-CSI-RS and the NZP-CSI-RS.

### <Periodic or Semi-Persistent CSI>

When the periodic or semi-persistent CSI is applied, each CSI report configuration (CSI-ReportConfig) is linked to periodic or semi-persistent resource setting.

When one resource configuration (given by the higher layer parameter resourcesForChannelMeasurement) is configured, the resource configuration is for channel measurement for calculation of the L1-RSRP.

When two resource configurations are configured, a first resource configuration (given by the higher layer parameter resourcesForChannelMeasurement) is for channel measurement, and a second resource configuration (given by the higher layer parameter csi-IM-ResourcesForInterference) is for interference measurement executed using the CSI-IM.

When the periodic or semi-persistent CSI is applied, NR may support only interference measurement based on the ZP-CSI-RS.

### <CSI-IM Resource and CSI-RS Resource>

The CSI-IM resources for interference measurement, the NZP-CSI-RS resources for interference measurement, and the NZP-CSI-RS resources for channel measurement are configured by higher layer signaling for one or more CSI resource configurations for channel and interference measurement.

The UE may assume that the NZP-CSI-RS resources for channel measurement and the CSI-IM resources for interference measurement configured for one CSI report are quasi-co-located (QCL) for each resource regarding “QCL-TypeD”. When the NZP-CSI-RS resources are used for interference measurement, the UE may assume that the NZP-CSI-RS resources for channel measurement and the CSI-IM resources or the NZP-CSI-RS resources for interference measurement configured for one CSI report are quasi-co-located (QCL) regarding “QCL-TypeD”.

In other words, when ZP-CSI-RS based interference measurement is applied, the UE may assume that the same receive beam as that indicated by the base station (gNB) for channel measurement is to be used for interference measurement.

### <CSI Report Configuration>

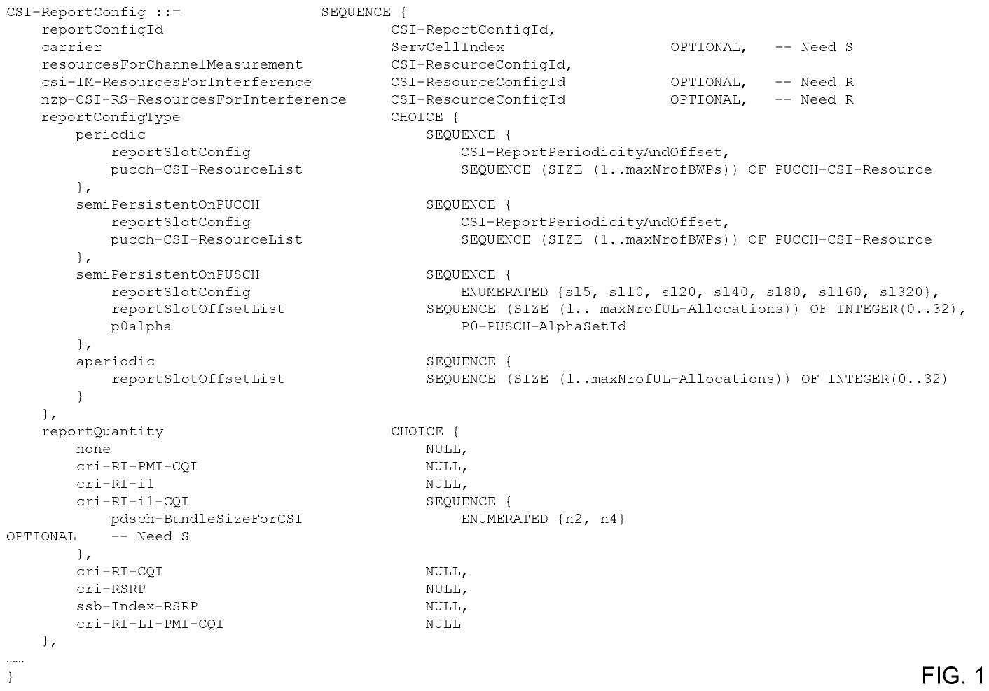

FIG. 1 is a diagram to show the CSI report configuration (CSI-ReportConfig) of 3GPP Rel. 16. As shown in FIG. 1, as the CSI report configuration being an information element of RRC, resources ForChannelMeasurement (CMR), csi-IM-ResourcesForInterference (ZP-IMR), nzp-CSI-RS-ResourcesForInterference (NZP-IMR), reportConfigType, and the like are configured. reportConfigType includes periodic, semiPersistentOnPUCCH, semiPersistentOnPUSCH, and aperiodic.

### <Implicit IMR Configuration>

Regarding the joint CSI report, the CMR for a certain CSI (TRP) may correspond to the IMR for another CSI (TRP). According to the configuration, it is expected that two CSIs included in the joint CSI report for NCJT transmission are well adapted to actual inter-TRP interference (accurate enough for direct scheduling). Performing further CSI update is not required depending on network implementation.

The UE may assume that explicit IMR configuration for inter-TRP interference is not to be performed regarding a certain CSI report configuration (joint CSI configuration). In this case, a specification may define assumption of an additional IMR when the joint CSI configuration is configured.

For example, it may be assumed that, in the joint CSI configuration, in addition to or instead of the explicit ZP-IMR/NZP-IMR, the CMR (resources indicated by resourcesForChannelMeasurement) for a certain TRP is included in (or is the same as) an additional NZP-IMR for another TRP (CMR). Here, the additional NZP-IMR for another TRP is not explicitly configured.

Information related to the additional NZP-IMR may be determined in a specification in advance, or may be reported to the UE by using at least one of RRC, MAC CE, and DCI.

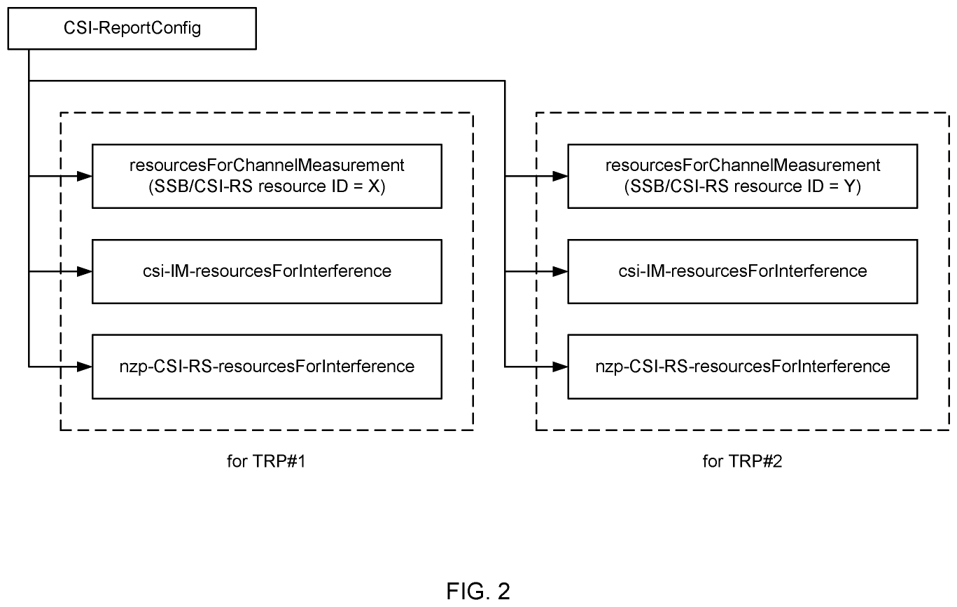

FIG. 2 is a diagram to show a first example of the CSI report configuration related to the implicit IMR configuration. In FIG. 2, SSB/CSI-RS ID=Y is not explicitly configured regarding the NZP-IMR for TRP #1, and the SSB/CSI-RS ID=X is not explicitly configured regarding the NZP-IMR for TRP #2.

Even when there is no explicit NZP-IMR configuration, the UE may assume that SSB/CSI-RS ID=Y corresponding to the CMR for TRP #2 corresponds to the NZP-IMR for TRP #1, or may assume that SSB/CSI-RS ID=X corresponding to the CMR for TRP #1 corresponds to the NZP-IMR for TRP #2. The UE may perform channel/interference measurement or the like based on these assumptions, and perform the joint CSI report.

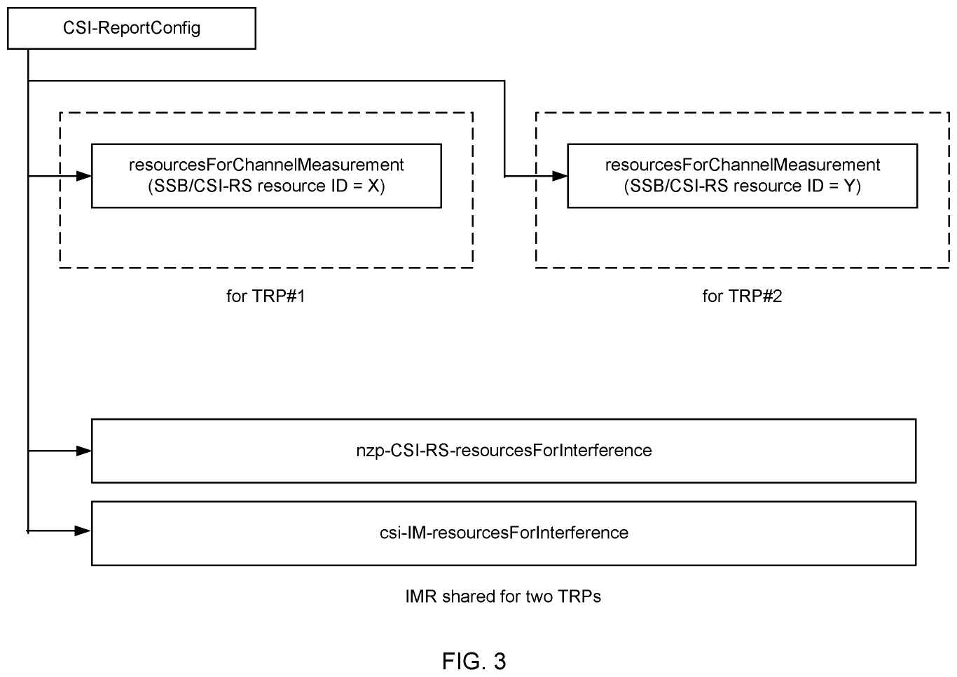

FIG. 3 is a diagram to show a second example of the CSI report configuration related to the implicit IMR configuration. FIG. 3 is similar to FIG. 2, and thus overlapping description will not be given. FIG. 3 is different from FIG. 2 in that the ZP-IMR and the NZP-IMR are configured to be common to (shared by) two TRPs.

The UE may use, as the NZP-IMR for TRP #1, the NZP-IMR configured to be common and SSB/CSI-RS ID=Y corresponding to the CMR for TRP #2. The UE may use, as the NZP-IMR for TRP #2, the NZP-IMR configured to be common and SSB/CSI-RS ID=X corresponding to the CMR for TRP #1.

However, in existing NR specifications such as those of Rel. 15, the multi panel/TRP is not taken into consideration, and accordingly how to perform measurement and report of CSI when the multi panel/TRP is used has not yet been clarified. How to perform joint between measurement/report in a multi panel/TRP hypothesis and a single panel/TRP hypothesis has not yet been clarified.

Unless measurement and report of the CSI is appropriately performed, system performance may be deteriorated, e.g., throughput may be reduced. In view of this, the inventors of the present invention came up with the idea of a method for appropriately performing measurement and report of CSI for a multi panel/TRP.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted as each other.

In the present disclosure, a panel, an Uplink (UL) transmission entity, a TRP, a spatial relation, a control resource set (CORESET), a PDSCH, a code word, a base station, an antenna port of a certain signal (for example, a demodulation reference signal (DMRS) port), an antenna port group of a certain signal (for example, a DMRS port group), a group for multiplexing (for example, a code division multiplexing (CDM) group, a reference signal group, a CORESET group), a CORESET pool, a CW, a redundancy version (RV), and a layer (a MIMO layer, a transmission layer, a spatial layer) may be interchangeably interpreted as each other. A panel Identifier (ID) and a panel may be interchangeably interpreted as each other. In the present disclosure, a TRP ID and a TRP may be interchangeably interpreted as each other.

In the present disclosure, NCJT, NCJT using a multi TRP, a multi PDSCH using NCJT, a multi PDSCH, a plurality of PDSCHs from a multi TRP, and the like may be interchangeably interpreted as each other. Note that the multi PDSCH may mean a plurality of PDSCHs in which at least a part of time resources (for example, one symbol) overlaps, may mean a plurality of PDSCHs in which all of time resources (for example, all symbols) overlap, may mean a plurality of PDSCHs in which none of time resources overlaps, may mean a plurality of PDSCHs carrying the same TB or the same CW, or may mean a plurality of PDSCHs to which different UE beams (spatial domain reception filters, QCL parameters) are applied.

In the present disclosure, a normal TRP, a single TRP, an STRP, a single TRP system, single TRP transmission, and a single PDSCH may be interchangeably interpreted as each other. In the present disclosure, a multi TRP, an MTRP, a multi TRP system, multi TRP transmission, and a multi PDSCH may be interchangeably interpreted as each other. In the present disclosure, a single DCI, a single PDCCH, a multi TRP based on a single DCI, and activation of two TCI states on at least one TCI code point may be interchangeably interpreted as each other.

In the present disclosure, a single TRP, a channel using a single TRP, a channel using one TCI state/spatial relation, no enabling of a multi TRP using RRC/DCI, no enabling of a plurality of TCI states/spatial relations using RRC/DCI, configuration of a CORESET pool index (CORESETPoolIndex) value for none of CORESETs and mapping of none of code points of a TCI field to two TCI states, performing communication with one transmission/reception point, and application of a single TRP may be interchangeably interpreted as each other.

In the present disclosure, a CRI index, a CRI, a CRI report index, and a reported CRI index may be interchangeably interpreted as each other.

In the present disclosure, an index, an ID, an indicator, a resource ID, and the like may be interchangeably interpreted as each other. In the present disclosure, a beam, a TCI, a TCI state, a DL TCI state, a UL TCI state, a unified TCI state, QCL, a QCL assumption, a spatial relation, spatial relation information, a precoder, and the like may be interchangeably interpreted as each other.

In the present disclosure, resource setting for channel measurement, a resource for channel measurement, a CSI-RS resource for channel measurement, resourcesForChannelMeasurement, a CMR, and a CMR resource may be interchangeably interpreted as each other.

In the present disclosure, a CSI-IM, a CSI-IM resource, a ZP-IMR, a ZP-IMR resource, a ZP-CSI-RS, a ZP-CSI-RS resource, CSI-IM resource setting for interference, a resource for CSI-IM based interference measurement, csi-IM-ResourceForInterference, a resource for interference measurement, and a CSI-RS resource for interference measurement may be interchangeably interpreted as each other.

In the present disclosure, an NZP-IM, an NZP-IM resource (NZP-IMR), an NZP-IMR resource, an NZP-CSI-RS, an NZP-CSI-RS resource, NZP-CSI-RS resource setting for interference, a resource for NZP-CSI-RS based interference measurement, nzp-CSI-RS-ResourcesForInterference, a resource for interference measurement, and a CSI-RS resource for interference measurement may be interchangeably interpreted as each other.

In the present disclosure, a CSI report, a CSI report configuration, a CSI configuration, a resource configuration, resource setting, and the like may be interchangeably interpreted as each other. In the present disclosure, to support, to control, to be able to control, to operate, to be able to operate, to execute, to be able to execute, and the like may be interchangeably interpreted as each other.

### (Radio Communication Method)

Based on at least one of resources (CMR) for first channel measurement corresponding to a first transmission/reception point (TRP) and resources (CMR) for second channel measurement corresponding to a second transmission/reception point (TRP), the UE may determine resources (ZP-IMR/NZP-IMR) for first interference measurement corresponding to the first TRP or resources (ZP-IMR/NZP-IMR) for second interference measurement corresponding to the second TRP. Then, the UE may transmit a channel state information (CSI) report, based on the first CMR and the second CMR.

The UE may transmit a report of a CSI pair including the first CMR and the second CMR corresponding to the same resources (ZP-IMR/NZP-IMR) for interference measurement.

The first TRP corresponds to TRP #1 to be described later, and the second TRP corresponds to TRP #2 to be described later. The first CMR corresponds to at least one of CMRs #0 to #3 to be described later, and the second CMR corresponds to at least one of CMRs #4 to #7 to be described later. The resources for first interference measurement correspond to at least one of CSI-IMs (ZP-IMRs) #a to #d or at least one of NZP-IMs #A to #D to be described later. The resources for second interference measurement correspond to at least one of CSI-IMs (ZP-IMRs) #e to #h or at least one of NZP-IMs #E to #H to be described later, for example. In the present disclosure, “first” and “second” may be replaced with each other.

In the present disclosure, a description that A (or B) corresponds to/is associated with B (or A), a description that the UE assumes/determines A (or B) as B (or A), and a description that the UE assumes/determines B (or A) based on A (or B) may be interchangeably interpreted as each other.

### First Embodiment

In a case of the periodic and semi-persistent CSI, NR may support only interference measurement based on the ZP-CSI-RS. When a specific (new) RRC parameter is configured, the UE may assume the CMR for another TRP as the NZP-IMR for the first TRP, and assume the CMR for the first TRP as the NZP-IMR for another TRP. When the specific (new) RRC parameter is not configured, the UE may execute interference measurement, based on only the ZP-IMR (CSI-IM).

In other words, when a specific higher layer parameter (RRC parameter) is configured, the UE may determine the non-zero power resources (NZP-IMR) for first interference measurement, based on the second CMR.

### [Option 1-1]

In the CMR configuration, up to N CMR (SSB/NZP-CSI-RS) resources may be configured for each TRP. Accordingly, a total of up to 2N CMRs may be configured in the CSI report configuration of the CMRs (resourcesForChannelMeasurement) of MTRP NCJT CSI configuration.

In CSI-IM configuration, a total of up to N ZP-CSI-RS resources may be configured, and two TRPs may share the ZP-CSI-RS resources.

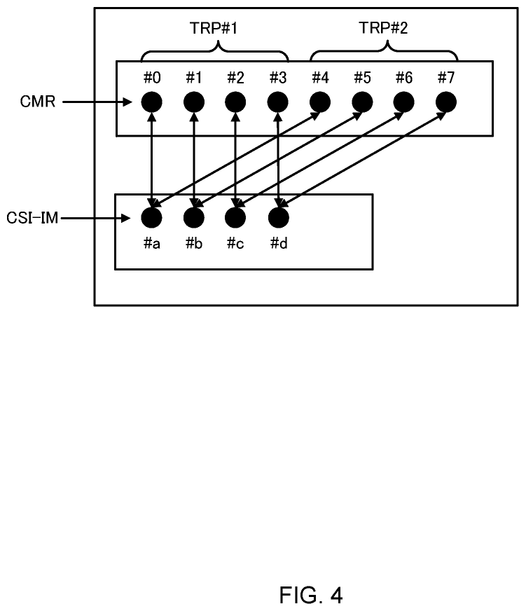

FIG. 4 is a diagram to show a relationship between the CMRs and the CSI-IMs in option 1-1 of a first embodiment. As shown in FIG. 4, up to four CMRs are configured for each of TRP #1 and TRP #2. CMRs #0 and #4 correspond to CSI-IM #a, CMRs #1 and #5 correspond to CSI-IM #b, CMRS #2 and #6 correspond to CSI-IM #c, and CMRs #3 and #7 correspond to CSI-IM #d.

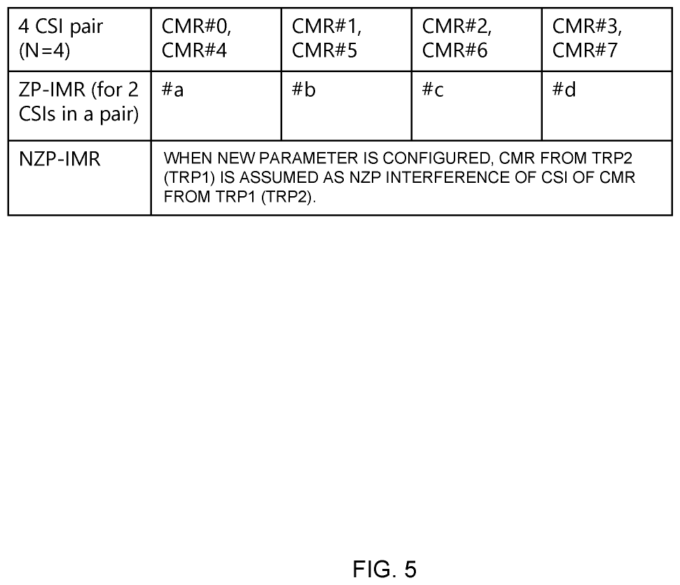

FIG. 5 is a diagram to show a relationship between the CSI pairs, the ZP-IMRs, and the NZP-IMRs in option 1-1 of the first embodiment. FIG. 5 corresponds to FIG. 4. As shown in FIG. 5, the CMRs corresponding to the same ZP-IMR (CSI-IM) and different TRPs are configured as the CSI pair. It is assumed that the ZP-IMRs and the NZP-IMRs are configuration in the CSI report configuration (the same applies to other figures as well).

The UE measures N pairs of CSIs from two TRPs of NCJT assumption. In each pair, a k-th CMR associated with each TRP is included (for example, a k-th CMR and a (k+N)-th CMR are included as a pair). Regarding two CSIs in each pair, the UE may assume one-to-one mapping between the CMRs and the CSI-IMs associated with each TRP.

After measuring each pair, the UE may report one (or a plurality of) CSI pair (s) selected for reporting among the pairs. The UE may determine the pair (s) to be reported/the number of pairs, based on a configuration according to a specification, RRC, or the like. Regarding the selected CSI pair (s), the UE may transmit a CSI report including the CRIs shown in the following options 1-1-1 and 1-1-2.

[[Option 1-1-1] ] Two CRIs (CRI j and CRI j+N) may correspond to two CSIs including one CSI by a (j+1)-th configured CMR and a (j+1)-th configured CSI-IM and another CSI by a (j+1+N)-th configured CMR and the (j+1)-th configured CSI-IM.
[[Option 1-1-2] ] One CRI (CRI j) may correspond to two CSIs including one CSI by a (j+1)-th configured CMR and a (j+1)-th configured CSI-IM and another CSI by a (j+1+N)-th configured CMR and the (j+1)-th configured CSI-IM. In option 1-1-2, one CRI (CRI j) means two CRIs for reporting CRI j and CRI j+N.

Good beam pairs may be reported in a group based beam report. In such a case, good beam pairs are already narrowed down, and thus configuring only N pairs as in the case of option 1-1 allows for simplification of processing. In this case, the base station (gNB) may be configured to acquire the CSIs of the reported beam pairs.

### [Option 1-2]

In the CMR configuration, up to N CMR (SSB/NZP-CSI-RS) resources may be configured for each TRP. Accordingly, a total of up to 2N CMRs may be configured in the CSI report configuration of the CMRs (resourcesForChannelMeasurement) of MTRP NCJT CSI configuration.

In the CSI-IM configuration, a total of up to N ZP-CSI-RS resources may be configured, and two TRPs may share the ZP-CSI-RS resources.

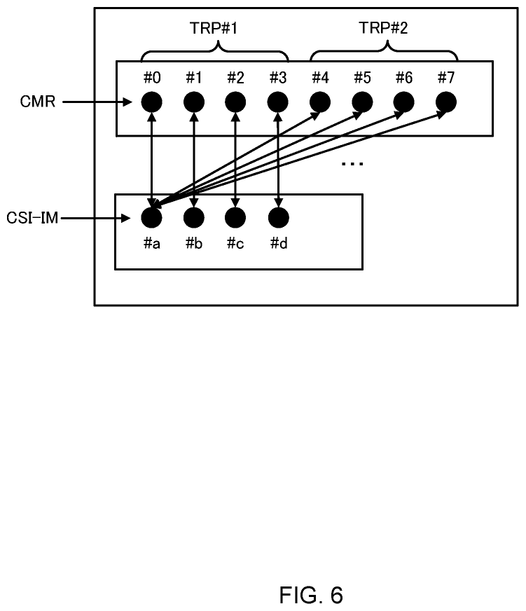

FIG. 6 is a diagram to show a relationship between the CMRs and the CSI-IMs in option 1-2 of the first embodiment. As shown in FIG. 6, up to four CMRs are configured for each of TRP #1 and TRP #2. CMRs #0 and #4 to #7 correspond to CSI-IM #a, CMRs #1 and #4 to #7 correspond to CSI-IM #b, CMRs #2 and #4 to #7 correspond to CSI-IM #c, and CMRs #3 and #4 to #7 correspond to CSI-IM #d. Note that a part of the correspondence is not shown in the figure.

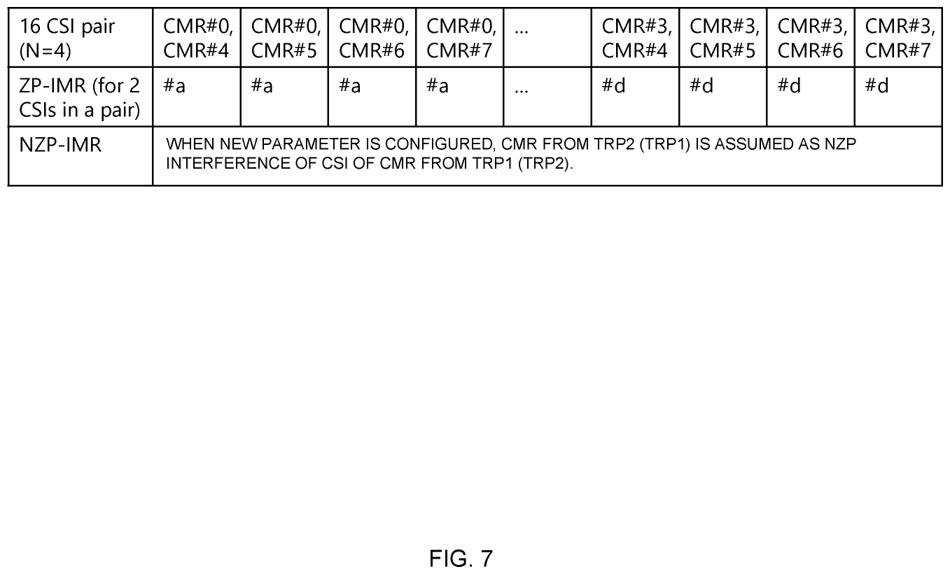

FIG. 7 is a diagram to show a relationship between the CSI pairs, the ZP-IMRs, and the NZP-IMRs in option 1-2 of the first embodiment. FIG. 7 corresponds to FIG. 6. As shown in FIG. 7, the CMRs corresponding to the same ZP-IMR (CSI-IM) and different TRPs are configured as the CSI pair. The example of FIG. 7 is different from the example of FIG. 5 in that the number of pairs is N×N.

The UE measures N×N pairs of CSIs from two TRPs of NCJT assumption. In each pair, CMRs of all conceivable combinations associated with each TRP are included. Regarding two CSIs in each pair, the UE assumes a k-th CSI-IM for interference measurement of the CSI pair including a k-th CMR.

Regarding one CSI pair selected for reporting, the UE may report two CRIS (CRI j (j≥0) and CRI p (p≥N)). The two CRIS may correspond to two CSIs including one CSI by a (j+1)-th configured CMR and a (j+1)-th configured CSI-IM and another CSI by a p-th configured CMR and the (j+1)-th configured CSI-IM.

### [Option 1-3]

In the CMR configuration, up to N CMR (SSB/NZP-CSI-RS) resources may be configured for each TRP. Accordingly, in the CSI report configuration of the CMRs of MTRP NCJT CSI configuration, a total of up to 2N CMRs may be configured.

In the CSI-IM configuration, up to N ZP-CSI-RS resources are configured for each TRP. Accordingly, in the CSI report configuration of the ZP-IMRS of MTRP NCJT CSI configuration, a total of up to 2N ZP-CSI-RS resources may be configured.

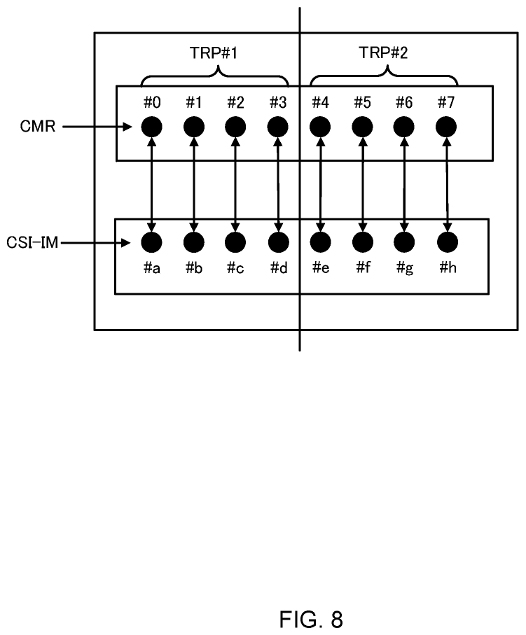

FIG. 8 is a diagram to show a relationship between the CMRs and the CSI-IMs in option 1-3 of the first embodiment. As shown in FIG. 8, up to four CMRs are configured for each of TRP #1 and TRP #2. CMRs #0 to #7 respectively correspond to CSI-IMs #a to #h on a one-to-one basis.

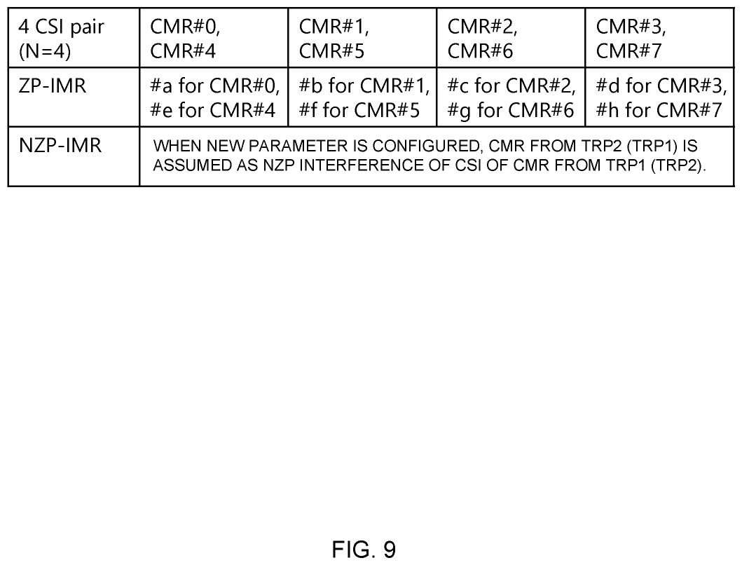

FIG. 9 is a diagram to show a relationship between the CSI pairs, the ZP-IMRs, and the NZP-IMRs in option 1-3 of the first embodiment. FIG. 9 corresponds to FIG. 8. FIG. 9 is different from FIG. 5 in that there are two ZP-IMRs (CSI-IMs) for one CSI pair.

The UE measures N pairs of CSIs from two TRPs of NCJT assumption. In each pair, a k-th CMR associated with each TRP is included (for example, a k-th CMR and a (k+N)-th CMR are included as a pair). Regarding two CSIs in each pair, the UE may assume one-to-one mapping between the CMRs and the CSI-IMs.

After measuring each pair, the UE may report one or a plurality of CSI pairs selected for reporting among the pairs. The UE may determine the pair (s) to be reported/the number of pairs, based on a configuration according to a specification, RRC, or the like. Regarding the selected CSI pair (s), the UE may transmit a CSI report including the CRIs shown in the following options 1-3-1 and 1-3-2.

[[Option 1-3-1] ] Two CRIs (CRI j and CRI j+N) may correspond to two CSIs including one CSI by a (j+1)-th configured CMR and a (j+1)-th configured CSI-IM and another CSI by a (j+1+N)-th configured CMR and a (j+1+N)-th configured CSI-IM.
[[Option 1-3-2] ] One CRI (CRI j) may correspond to two CSIs including one CSI by a (j+1)-th configured CMR and a (j+1)-th configured CSI-IM and another CSI by a (j+1+N)-th configured CMR and a (j+1+N)-th configured CSI-IM. In option 1-3-2, one CRI (CRI j) means two CRIs for reporting CRI j and CRI j+N.

### [Option 1-4]

In the CMR configuration, up to N CMRs (SSBs/NZP-CSI-RSs) may be configured for each TRP. Accordingly, a total of up to 2N CMRs may be configured in the CSI report configuration of the CMRs (resources ForChannelMeasurement) of MTRP NCJT CSI configuration.

In the CSI-IM configuration, up to N ZP-CSI-RS resources are configured for each TRP. Accordingly, in the CSI report configuration of the ZP-IMRs of MTRP NCJT CSI configuration, a total of up to 2N ZP-CSI-RS resources may be configured.

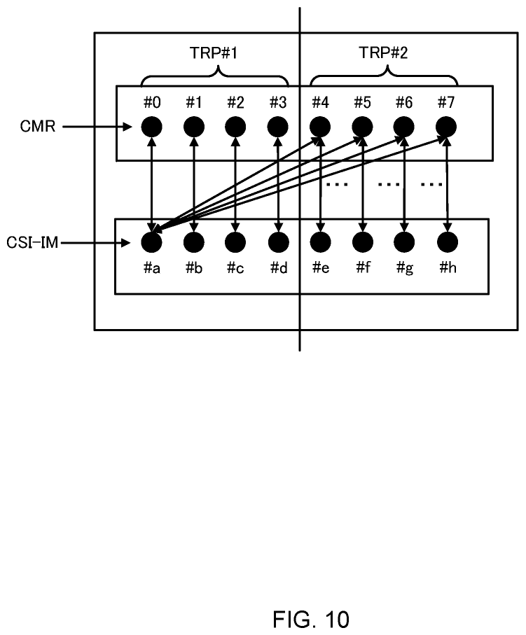

FIG. 10 is a diagram to show a relationship between the CMRs and the CSI-IMs in option 1-4 of the first embodiment. As shown in FIG. 10, up to four CMRs are configured for each of TRP #1 and TRP #2. CMRs #0 and #4 to #7 correspond to CSI-IM #a, CMRs #1 and #4 to #7 correspond to CSI-IM #b, CMRs #2 and #4 to #7 correspond to CSI-IM #c, and CMRs #3 and #4 to #7 correspond to CSI-IM #d. In addition, CMRs #4 to #7 respectively correspond to CSI-IMs #e to #h on a one-to-one basis. Note that a part of the correspondence is not shown in the figure.

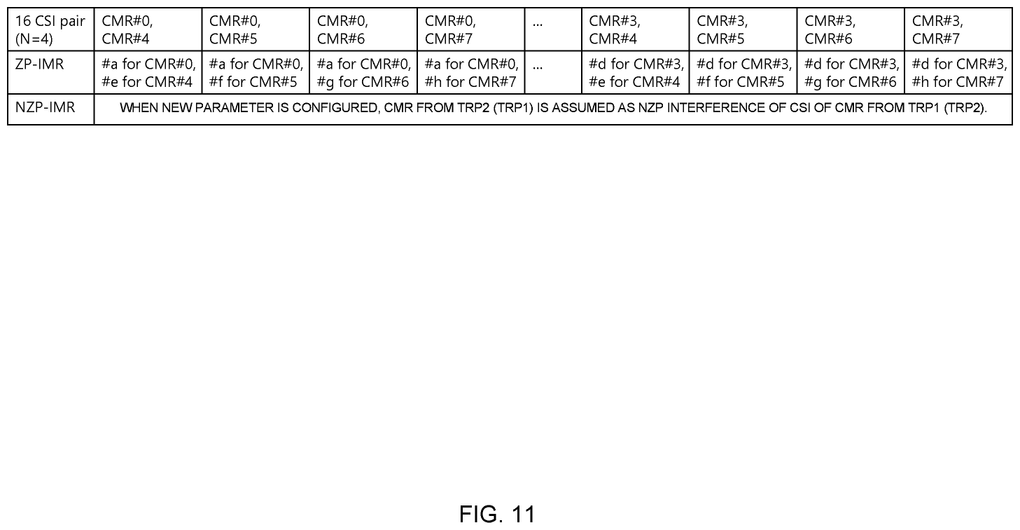

FIG. 11 is a diagram to show a relationship between the CSI pairs, the ZP-IMRs, and the NZP-IMRs in option 1-4 of the first embodiment. FIG. 11 corresponds to FIG. 10. As shown in FIG. 11, the CMRs corresponding to the same ZP-IMR (CSI-IM) are configured as the CSI pair. FIG. 11 is different from FIG. 7 in that there are two ZP-IMRs (CSI-IMs) for one CSI pair.

The UE measures N×N pairs of CSIs from two TRPs of NCJT assumption. In each pair, CMRs of all conceivable combinations associated with each TRP are included. Regarding two CSIs in each pair, the UE assumes a k-th CSI-IM for interference measurement of a k-th CMR.

Regarding one CSI pair selected for reporting, the UE may report two CRIs (CRI j (j≥0) and CRI p (p≥N)). The two CRIs may correspond to two CSIs including one CSI by a (j+1)-th configured CMR and a (j+1)-th configured CSI-IM and another CSI by a p-th configured CMR and a p-th configured CSI-IM.

According to the first embodiment, mapping between the CMRs and the ZP-IMRs/NZP-IMRs for two TRPs is clarified regarding CSI measurement associated with the CSI report configuration of NCJT in a case of the periodic and semi-persistent CSI.

### Second Embodiment

In a case of the aperiodic CSI, NR may support interference measurement based on only the ZP-CSI-RS, only the NZP-CSI-RS, and both of the ZP-CSI-RS and the NZP-CSI-RS. In the aperiodic CSI, when interference measurement is configured based on only the ZP-CSI-RS, methods of options of the first embodiment may be applied.

In the aperiodic CSI, when interference measurement is configured based on only the ZP-CSI-RS, or both of the ZP-CSI-RS and the NZP-CSI-RS, one of the following aspects 1 to 3 may be applied.

[Aspect 1] For two CSIs as the CSI pair, the UE does not assume the CMRs for one TRP as the NZP-IMRs for another TRP.
[Aspect 2] For two CSIs as the CSI pair, when being indicated by a specific (new) RRC parameter, the UE assumes the CMRs for one TRP as the NZP-IMRs for another TRP.
[Aspect 3] For two CSIs as the CSI pair of aperiodic CSIs, when being indicated to assume the CMRs for one TRP as the NZP-IMRs for another TRP by a specific (new) RRC parameter, the UE does not assume that the NZP-CSI-RSs for interference measurement are configured.

In aspects 1 to 3, at least one of options 2-1 to 2-4 to be described later may be applied to mapping between the CMRs and the CSI-IMs/NZP-CSI-RSS (NZP-IMRs). The main difference between options 2-1 to 2-4 and option 1-1 to 1-4 is that the NZP-CSI-RSS (NZP-IMRs) for interference measurement are taken into consideration.

### [Option 2-1]

In the CMR configuration, up to N CMR (SSB/NZP-CSI-RS) resources may be configured for each TRP. Accordingly, a total of up to 2N CMRs may be configured in the CSI report configuration of the CMRs (resources ForChannelMeasurement) of MTRP NCJT CSI configuration.

In the CSI-IM configuration, a total of up to N ZP-CSI-RS resources may be configured, and two TRPs may share the ZP-CSI-RS resources.

For the NZP-CSI-RSs for interference measurement, a total of up to N NZP-CSI-RS resources may be configured, and two TRPs may share the NZP-CSI-RS resources.

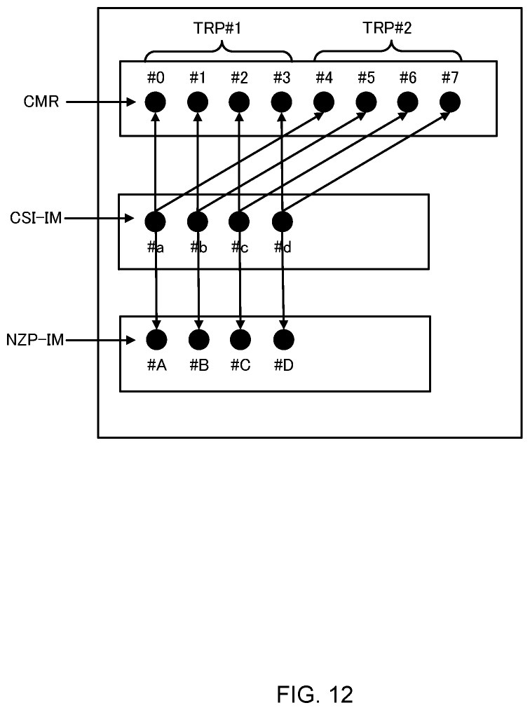

FIG. 12 is a diagram to show a relationship between the CMRs, the CSI-IMs, and the NZP-IMs in option 2-1 of a second embodiment. As shown in FIG. 12, up to four CMRs are configured for each of TRP #1 and TRP #2. CMRs #0 and #4 correspond to CSI-IM #a and NZP-IM #A, CMRs #1 and #5 correspond to CSI-IM #b and NZP-IM #B, CMRs #2 and #6 correspond to CSI-IM #c and NZP-IM #C, and CMRs #3 and #7 correspond to CSI-IM #d and NZP-IM #D.

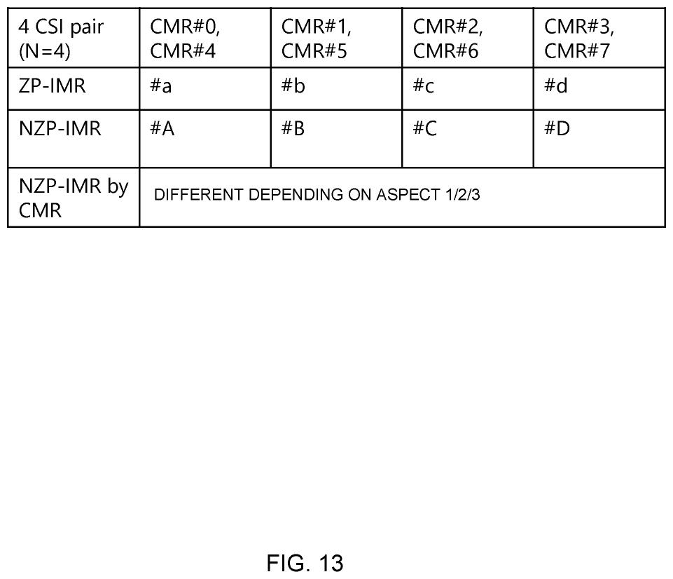

FIG. 13 is a diagram to show a relationship between the CSI pairs, the ZP-IMRs, and the NZP-IMRs in option 2-1 of the second embodiment. FIG. 13 corresponds to FIG. 12. As shown in FIG. 13, the CMRs corresponding to the same ZP-IMR (CSI-IM) and NZP-IM and different TRPs are configured as the CSI pair. It is assumed that the ZP-IMRs and the NZP-IMRs are configuration in the CSI report configuration (the same applies to other figures as well). NZP-IMR by CMR is an NZP-IMR assumed using a CMR, and differs depending on which of aspects 1 to 3 described above is applied (the same applies to other figures as well).

The UE measures N pairs of CSIs from two TRPs of NCJT assumption. In each pair, a k-th CMR associated with each TRP is included (for example, a k-th CMR and a (k+N)-th CMR are included as a pair). Regarding two CSIs in each pair, the UE may assume one-to-one mapping between the CMRs and the CSI-IMs/NZP-CSI-RSS associated with each TRP.

After measuring each pair, the UE may report one or a plurality of CSI pairs selected for reporting among the pairs. The UE may determine the pair (s) to be reported/the number of pairs, based on a configuration according to a specification, RRC, or the like. Regarding the selected CSI pair (s), the UE may transmit a CSI report including the CRIs shown in the following options 2-1-1 and 2-1-2.

[[Option 2-1-1] ] Two CRIs (CRI j and CRI j+N) may correspond to two CSIs including one CSI by a (j+1)-th configured CMR and a (j+1)-th configured CSI-IM/NZP-IM and another CSI by a (j+1+N)-th configured CMR and the (j+1)-th configured CSI-IM/NZP-IM.
[[Option 2-1-2] ] One CRI (CRI j) may correspond to two CSIs including one CSI by a (j+1)-th configured CMR and a (j+1)-th configured CSI-IM/NZP-IM and another CSI by a (j+1+N)-th configured CMR and the (j+1)-th configured CSI-IM/NZP-IM. In option 1-1-2, one CRI (CRI j) means two CRIs for reporting CRI j and CRI j+N.

Good beam pairs may be reported in a group based beam report. In such a case, good beam pairs are already narrowed down, and thus configuring only N pairs as in the case of option 2-1 allows for simplification of processing. In this case, the base station (gNB) may be configured to acquire the CSIs of the reported beam pairs.

### [Option 2-2]

In the CMR configuration, up to N CMR (SSB/NZP-CSI-RS) resources may be configured for each TRP. Accordingly, a total of up to 2N CMRs may be configured in the CSI report configuration of the CMRs (resources ForChannelMeasurement) of MTRP NCJT CSI configuration.

In the CSI-IM configuration, a total of up to N ZP-CSI-RS resources may be configured, and two TRPs may share the ZP-CSI-RS resources.

For the NZP-CSI-RSs for interference measurement, a total of up to N NZP-CSI-RS resources may be configured, and two TRPs may share the NZP-CSI-RS resources.

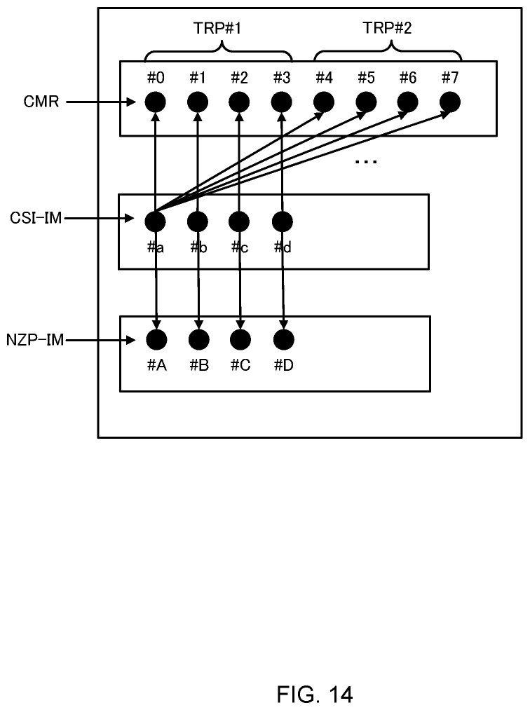

FIG. 14 is a diagram to show a relationship between the CMRs and the CSI-IMs in option 2-2 of the second embodiment. As shown in FIG. 14, up to four CMRs are configured for each of TRP #1 and TRP #2. CMRs #0 and #4 to #7 correspond to CSI-IM #a and NZP-IM #A, CMRs #1 and #4 to #7 correspond to CSI-IM #b and NZP-IM #B, CMRs #2 and #4 to #7 correspond to CSI-IM #c and NZP-IM #C, and CMRs #3 and #4 to #7 correspond to CSI-IM #d and NZP-IM #D. Note that a part of the correspondence is not shown in the figure.

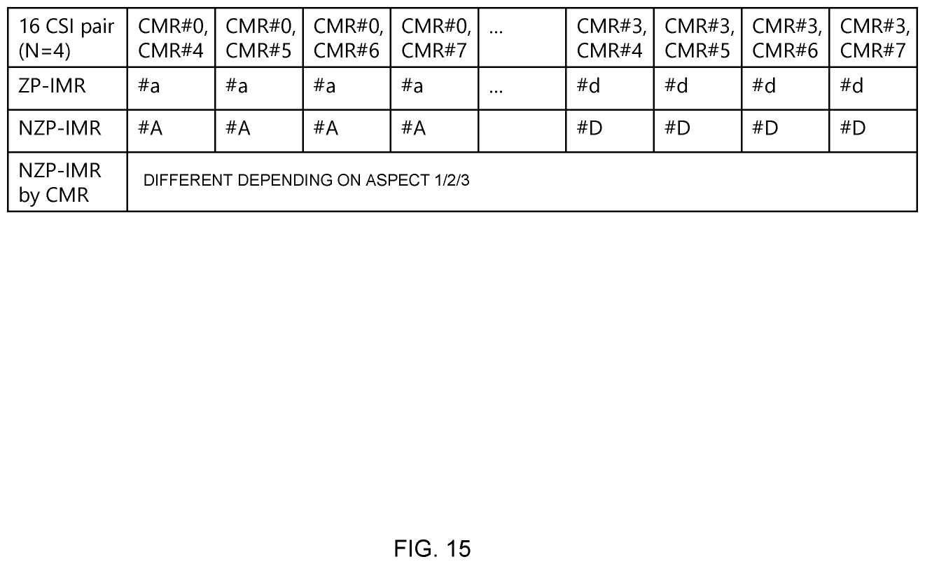

FIG. 15 is a diagram to show a relationship between the CSI pairs, the ZP-IMRs, and the NZP-IMRs in option 2-2 of the second embodiment. FIG. 15 corresponds to FIG. 14. As shown in FIG. 15, the CMRs corresponding to the same ZP-IMR (CSI-IM) and NZP-IM and different TRPs are configured as the CSI pair. The example of FIG. 15 is different from the example of FIG. 13 in that the number of pairs is N×N. “NZP-IMR by CMR” differs depending on which of aspects 1 to 3 described above is applied.

The UE measures N×N pairs of CSIs from two TRPs of NCJT assumption. In each pair, CMRs of all conceivable combinations associated with each TRP are included. Regarding two CSIs in each pair, the UE assumes a k-th CSI-IM and a k-th NZP-IM for interference measurement of the CSI pair including a k-th CMR.

Regarding one CSI pair selected for reporting, the UE may report two CRIS (CRI j (j≥0) and CRI p (p≥N)). The two CRIS may correspond to two CSIs including one CSI by a (j+1)-th configured CMR and a (j+1)-th configured CSI-IM/NZP-IM and another CSI by a p-th configured CMR and the (j+1)-th configured CSI-IM/NZP-IM.

### [Option 2-3]

In the CMR configuration, up to N CMRs (SSBs/NZP-CSI-RSs) may be configured for each TRP. Accordingly, in the CSI report configuration of the CMRs of MTRP NCJT CSI configuration, a total of up to 2N CMRs may be configured.

In the CSI-IM configuration, up to N ZP-CSI-RS resources are configured for each TRP. Accordingly, in the CSI report configuration of the ZP-IMRs of MTRP NCJT CSI configuration, a total of up to 2N ZP-CSI-RS resources may be configured.

In the NZP-IM configuration, up to N NZP-CSI-RS resources are configured for each TRP. Accordingly, for the total of the CSI report configuration of the NZP-IMRs of MTRP NCJT CSI configuration, up to 2N NZP-CSI-RS resources may be configured.

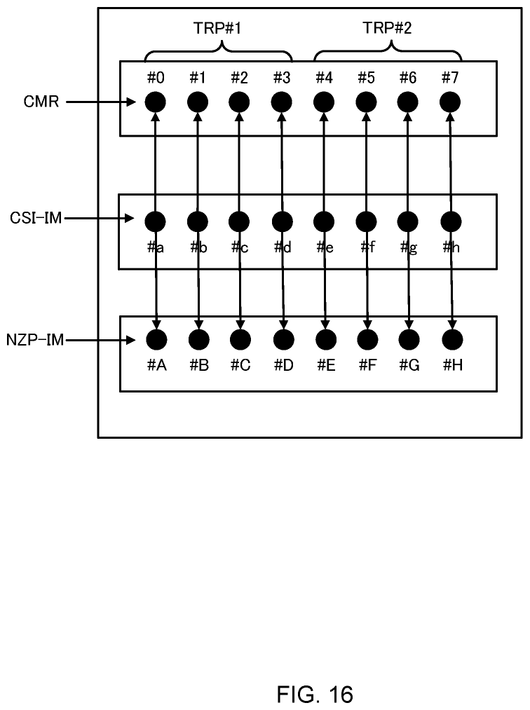

FIG. 16 is a diagram to show a relationship between the CMRs and the CSI-IMs in option 2-3 of the second embodiment. As shown in FIG. 16, up to four CMRs are configured for each of TRP #1 and TRP #2. CMRs #0 to #7 respectively correspond to CSI-IMs #a to #h and NZP-IMs #A to #H on a one-to-one basis.

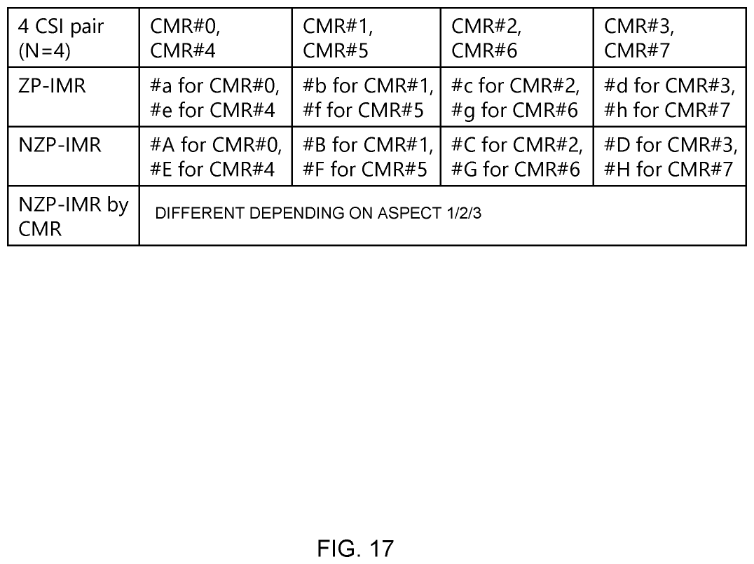

FIG. 17 is a diagram to show a relationship between the CSI pairs, the ZP-IMRs, and the NZP-IMRs in option 2-3 of the second embodiment. FIG. 17 corresponds to FIG. 16. FIG. 17 is different from FIG. 13 in that there are two ZP-IMRs (CSI-IMs) and NZP-IMs for one CSI pair.

The UE measures N pairs of CSIs from two TRPs of NCJT assumption. In each pair, a k-th CMR associated with each TRP is included (for example, a k-th CMR and a (k+N)-th CMR are included as a pair). Regarding two CSIs in each pair, the UE may assume one-to-one mapping between the CMRs and the CSI-IMs/NZP-IMs (NZP-CSI-RSs for IM).

After measuring each pair, the UE may report one or a plurality of CSI pairs selected for reporting among the pairs. The UE may determine the pair (s) to be reported/the number of pairs, based on a configuration according to a specification, RRC, or the like. Regarding the selected CSI pair (s), the UE may transmit a CSI report including the CRIs shown in the following options 2-3-1 and 2-3-2.

[[Option 2-3-1] ] Two CRIs (CRI j and CRI j+N) may correspond to two CSIs including one CSI by a (j+1)-th configured CMR and a (j+1)-th configured CSI-IM/NZP-IM and another CSI by a (j+1+N)-th configured CMR and a (j+1+N)-th configured CSI-IM/NZP-IM.
[[Option 2-3-2] ] One CRI (CRI j) may correspond to two CSIs including one CSI by a (j+1)-th configured CMR and a (j+1)-th configured CSI-IM/NZP-IM and another CSI by a (j+1+N)-th configured CMR and a (j+1+N)-th configured CSI-IM/NZP-IM. In option 1-3-2, one CRI (CRI j) means two CRIs for reporting CRI j and CRI j+N.

### [Option 2-4]

In the CMR configuration, up to N CMR (SSB/NZP-CSI-RS) resources may be configured for each TRP. Accordingly, in the CSI report configuration of the CMRs (resources ForChannelMeasurement) of MTRP NCJT CSI configuration, a total of up to 2N CMRs may be present.

In the CSI-IM configuration, up to N ZP-CSI-RS resources are configured for each TRP. Accordingly, in the CSI report configuration of the ZP-IMRs of MTRP NCJT CSI configuration, a total of up to 2N ZP-CSI-RS resources may be configured.

In the NZP-IM configuration, up to N NZP-CSI-RS resources are configured for each TRP. Accordingly, in the CSI report configuration of the NZP-IMRs of MTRP NCJT CSI configuration, a total of up to 2N NZP-CSI-RS resources may be configured.

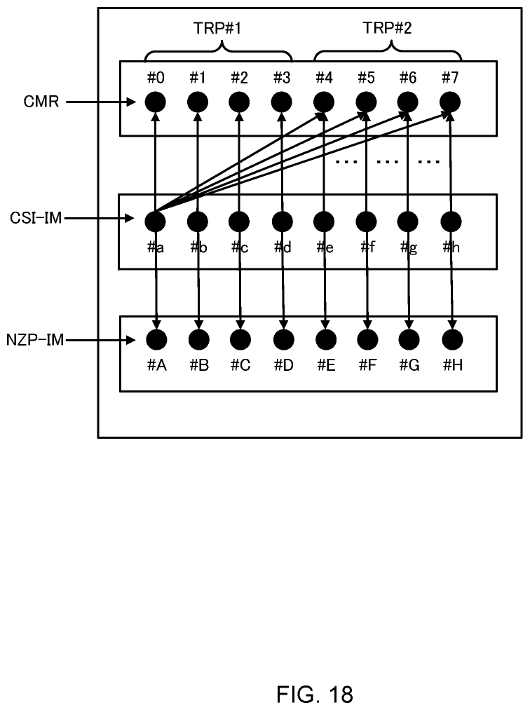

FIG. 18 is a diagram to show a relationship between the CMRs and the CSI-IMs in option 2-4 of the second embodiment. As shown in FIG. 18, up to four CMRs are configured for each of TRP #1 and TRP #2. CMRs #0 and #4 to #7 correspond to CSI-IM #a and NZP-IM #A, CMRs #1 and #4 to #7 correspond to CSI-IM #b and NZP-IM #B, CMRs #2 and #4 to #7 correspond to CSI-IM #c and NZP-IM #C, and CMRs #3 and #4 to #7 correspond to CSI-IM #d and NZP-IM #D. In addition, CMRs #4 to #7 respectively correspond to CSI-IMs #e to #h and NZP-IMs #A to #H on a one-to-one basis. Note that a part of the correspondence is not shown in the figure.

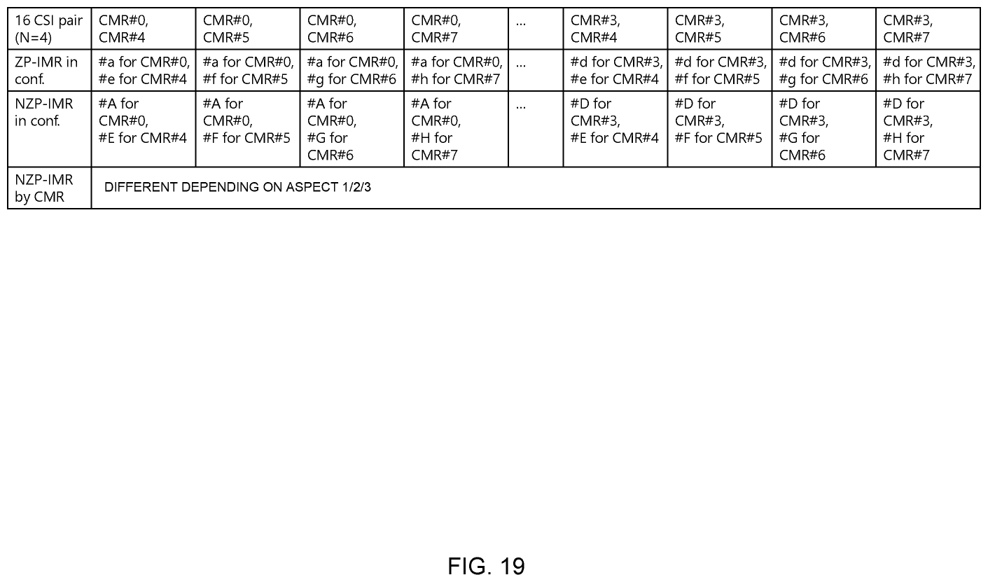

FIG. 19 is a diagram to show a relationship between the CSI pairs, the ZP-IMRs, and the NZP-IMRs in option 2-4 of the second embodiment. FIG. 19 corresponds to FIG. 18. As shown in FIG. 19, the CMRs corresponding to the same ZP-IMR (CSI-IM) and NZP-IM are configured as the CSI pair. FIG. 19 is different from FIG. 15 in that there are two ZP-IMRs (CSI-IMs) and NZP-IMs for one CSI pair.

The UE measures N×N pairs of CSIs from two TRPs of NCJT assumption. In each pair, CMRs of all conceivable combinations associated with each TRP are included. Regarding two CSIs in each pair, the UE assumes a k-th CSI-IM/NZP-IM for interference measurement of a k-th CMR.

Regarding one CSI pair selected for reporting, the UE may report two CRIS (CRI j (j≥0) and CRI p (p≥N)). The two CRIS may correspond to two CSIs including one CSI by a (j+1)-th configured CMR and a (j+1)-th configured CSI-IM/NZP-IM and another CSI by a p-th configured CMR and a p-th configured CSI-IM/NZP-IM.

According to the second embodiment, mapping between the CMRs and the ZP-IMRs/NZP-IMRs for two TRPs is clarified regarding CSI measurement associated with the CSI report configuration of NCJT in the aperiodic CSI.

### Third Embodiment

When the UE applies joint channel state information report (joint CSI report), the UE receives configuration information (for example, CSI-ReportConfig) corresponding to both of application of the resources for channel measurement (CMR) for a plurality of transmission/reception points (multi TRP) and application of the CMRs for a single TRP, and controls transmission of the CSI report, based on the configuration information. The UE may measure the CMR resources measured as the CSI pairs for the multi TRP for an individual single TRP (option 3-1). The UE may receive configuration information in which the IMRs measured for a single TRP and the IMRs (CSI-IMs/NZP-IMRs) measured for the multi TRP are independently (individually) configured, and control transmission (generation) of the CSI report, based on the configuration information (option 3-2).

### [Option 3-1]

When a joint CSI report corresponding to (or including) the best CSI for the multi TRP and the best CSI/second best CSI from each TRP (two TRPs) for the single TRP is configured, the CMR resources measured by the UE as the CSI pairs for the multi TRP are measured by the UE for an individual single TRP hypothesis (which may be referred to as a presupposition or an assumption).

In the present disclosure, a CSI pair and a beam pair may be interchangeably interpreted as each other. The single TRP may mean that only one TRP out of the multi TRP performs transmission to the UE, or mean the one TRP itself.

Note that, in the present disclosure, a certain resource (CMR/CSI-IM/NZP-IMR) being configured before (for example, being configured first) another resource (CMR/CSI-IM/NZP-IMR) may mean that an index of the certain resource is smaller than an index of the another resource. A certain resource being configured subsequently to (being configured after) another resource may mean that an index of the certain resource is larger than an index of the another resource.

In the CMR resource configuration, as order of the CMR resources from two TRPs, the following option 3-1-1 or option 3-1-2 is applied.

### [Option 3-1-1]

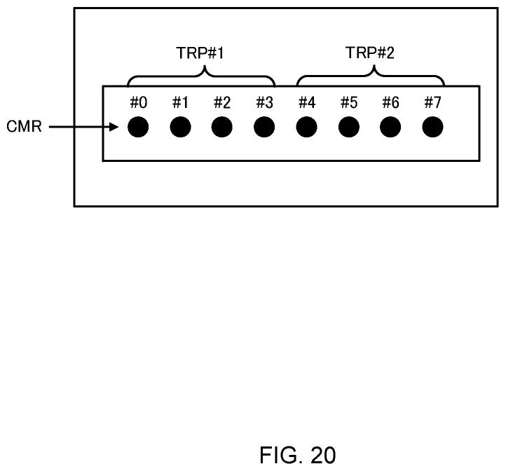

Similarly to the first embodiment and the second embodiment, the CMRs corresponding to TRP #1 may be configured first, and the CMRs corresponding to TRP #2 may be configured subsequently. FIG. 20 is a diagram to show a configuration example of the CMRs in option 3-1-1 of a third embodiment. As shown in FIG. 20, CMRs #0 to #3 correspond to TRP #1, and CMRs #4 to #7 correspond to TRP #2. CMRs #0 to #3 and CMRs #4 to #7 may each correspond to four beams (CSIs) for one single TRP. As the CSI pairs for the multi TRP, the 4 or 16 CSI pairs shown in one of the first embodiment/second embodiment may be configured. In other words, CMRs #0 to #7 are used for both of the single TRP and the multi TRP.

### [Option 3-1-2]

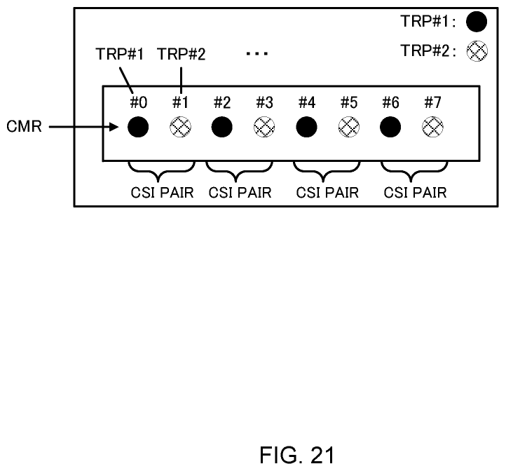

The CMRs may be configured in order for each CSI pair. For example, for each CSI pair, TRP #1 may be configured first, and TRP #2 may be configured subsequently. FIG. 21 is a diagram to show a configuration example of the CMRs in option 3-1-2 of the third embodiment. As shown in FIG. 21, CMRs #0, #2, #4, and #6 correspond to TRP #1, and CMRs #1, #3, #5, and #7 correspond to TRP #2. CMRs #0, #2, #4, and #6 and CMRs #1, #3, #5, and #7 may each correspond to four beams (CSIs) for one single TRP. As the CSI pairs for the multi TRP, a pair of CMRs #0 and #1, a pair of CMRs #2 and #3, a pair of CMRs #4 and #5, and a pair of CMRs #6 and #7 may each be configured. In other words, CMRs #0 to #7 are used for both of the single TRP and the multi TRP.

In the CRI report, order of the CRI indexes for the single TRP and the CSI indexes for the multi TRP may be interchanged. The CRI indexes may be configured as shown in option 3-1-3 or option 3-1-4, or may be determined in a specification in advance as shown in these options, for example.

### [Option 3-1-3]

A reported CRI k (k≥0) means a CSI for the single TRP, based on a (k+1)-th CMR resource. The CRI indexes corresponding to the CSIs for the multi TRP start from 2N. N is the number of CMR resources for each TRP. In other words, the CSIs for the single TRP may correspond to CRI indexes 0 to 2N−1, and the CSIs for the multi TRP may correspond to CRI index 2N or greater. Similarly to the first embodiment and the second embodiment, CRI index j corresponding to the multi TRP corresponds to two CMR resources as the CSI pair (for example, (j+1−2N)-th CSI pair).

For example, CRIs #0 to #3 may correspond to TRP #1 (single TRP), CRIS #4 to #7 may correspond to TRP #2 (single TRP), and CRIS #8 to #11 may correspond to four CSI pairs for the multi TRP.

### [Option 3-1-4]

CRI k (k≥0) means a CSI for the multi TRP with CSI pairs. The CRI indexes corresponding to the single TRP start from N. In other words, the CSIs for the multi TRP may correspond to CRI indexes 0 to N−1, and the CSIs for the multi TRP may correspond to CRI index N or greater.

For example, CRIS #0 to #3 may correspond to four CSI pairs for the multi TRP, CRIS #4 to #7 may correspond to TRP #1 (single TRP), and CRIS #8 to #11 may correspond to TRP #2 (single TRP).

### [Option 3-2]

The IMR resources of the single TRP hypothesis may be additionally configured, or may be specific to the TRP. The IMR resources of the single TRP hypothesis may be different from the IMR resources of the multi TRP hypothesis. Order of the IMRs for the single TRP and the IMRs for the multi TRP may be interchanged. One-to-one mapping between the CMRs and the IMRs of the single TRP hypothesis may be performed as in the following option 3-2-1 or option 3-2-2, for example.

### [Option 3-2-1]

The CSI-IMs/NZP-IMRs corresponding to the multi TRP may be configured first, and the CSI-IMs/NZP-IMRs corresponding to the single TRP may be configured subsequently. Regarding the CSI-IMs/NZP-IMRs, TRP #1 may be configured first, and TRP #2 may be configured subsequently.

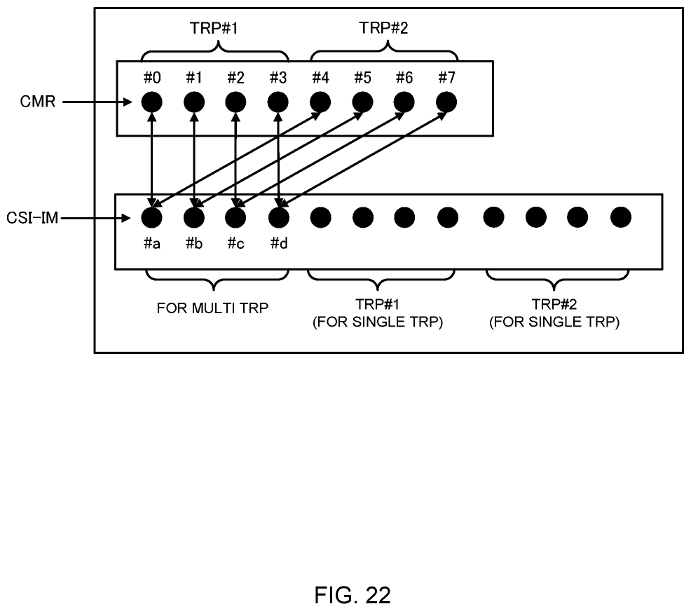

FIG. 22 is a diagram to show a configuration example of the CMRs/CSI-IMs in option 3-2-1 of the third embodiment. FIG. 22 presupposes option 1-1 of the first embodiment. Description of similarities to option 1-1 will be omitted. In FIG. 22, in the configuration of the CSI-IMs, the CSI-IMs corresponding to the multi TRP are configured first, and the CSI-IMs corresponding to TRP #1 (for the single TRP) and the CSI-IMs corresponding to TRP #2 (for the single TRP) are configured subsequently successively. Note that the configuration of the NZP-IMRs may be similar to the configuration of the CSI-IMs as well.

### [Option 3-2-2]

The CSI-IMs/NZP-IMRs corresponding to the single TRP may be configured first, and the CSI-IMs/NZP-IMRs corresponding to the multi TRP may be configured subsequently. Regarding the CSI-IMs/NZP-IMRs, TRP #1 may be configured first, and TRP #2 may be configured subsequently.

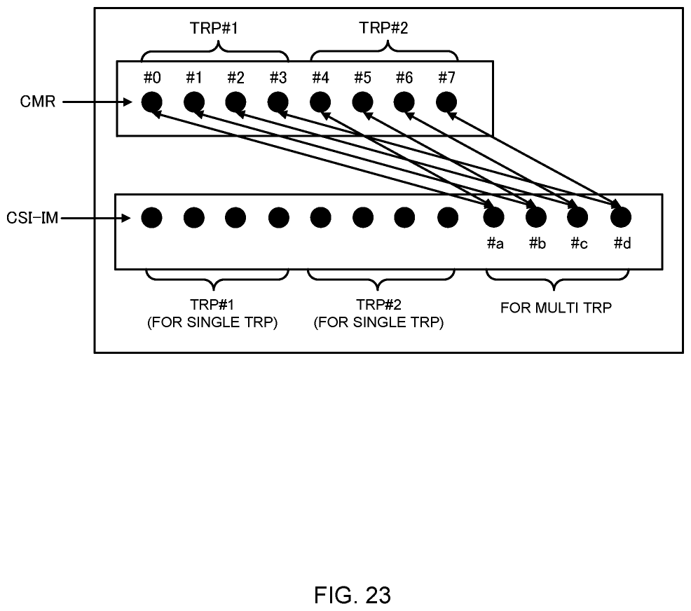

FIG. 23 is a diagram to show a configuration example of the CMRs/CSI-IMs in option 3-2-2 of the third embodiment. FIG. 23 presupposes option 1-1 of the first embodiment. Description of similarities to option 1-1 will be omitted. In FIG. 23, in the configuration of the CSI-IMs, the CSI-IMs corresponding to TRP #1 (for the single TRP) and the CSI-IMs corresponding to TRP #2 (for the single TRP) are configured first successively, and the CSI-IMs corresponding to the multi TRP are configured subsequently. Note that the configuration of the NZP-IMRs may be similar to the configuration of the CSI-IMs as well.

Option 3-2-1 and option 3-2-2 presuppose option 1-1 of the first embodiment, but may presuppose other options of the first embodiment and the second embodiment.

According to the third embodiment, a joint method for measurement/report in the multi panel/TRP hypothesis and measurement/report in the single panel/TRP hypothesis is clarified. This allows for application of one CMR to both of the multi panel and the single panel, and can thus reduce the number of configurations and enhance throughput.

### Fourth Embodiment

When the UE applies joint channel state information report (joint CSI report), the UE receives configuration information corresponding to both of application of the resources for channel measurement (CMR) for a plurality of transmission/reception points (multi TRP) and application of the CMRs for a single TRP, and controls transmission of the CSI report, based on the configuration information. In the configuration information, the CMR resources measured for the single TRP and the CMR resources measured as the CSI pairs for the multi TRP are independently (individually) configured (option 4-1). The UE may receive configuration information in which the IMRs measured for a single TRP and the IMRs (CSI-IMs/NZP-IMRs) measured for the multi TRP are independently (individually) configured, and control transmission (generation) of the CSI report, based on the configuration information (option 4-2).

### [Option 4-1]

When a joint CSI report corresponding to (or including) the best CSI for the multi TRP and the best CSI/second best CSI from each TRP (two TRPs) for the single TRP is configured, the CMR resources measured by the UE in a case of the single TRP hypothesis may be configured independently from the CMR resources measured by the UE as the CSI pairs of the multi TRP hypothesis.

In the CMR resource configuration, order of the CMRs for the single TRP and the CMRs for the multi TRP may be interchanged.

### [Option 4-1-1]

The CMRs (N beam pairs) for the multi TRP may be configured first, and the CMRs (M CMRs per TRP) for the single TRP may be configured subsequently. M and N may be configured using higher layer signaling or the like, for example.

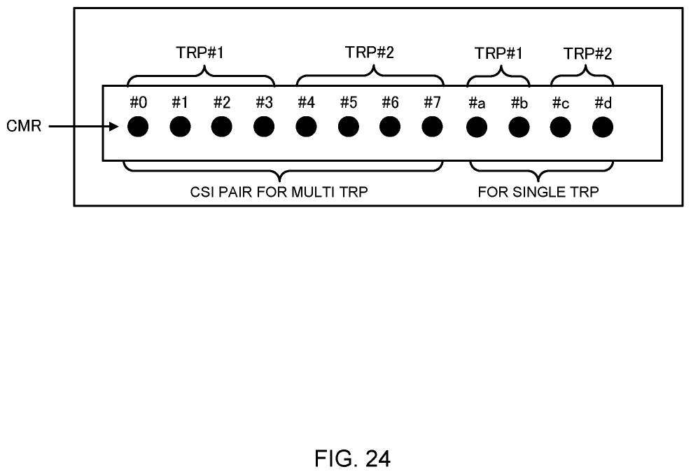

FIG. 24 is a diagram to show a first configuration example of the CMRs in option 4-1-1 of a fourth embodiment. As shown in FIG. 24, CMRs #0 to #3 correspond to TRP #1 (for the multi TRP), and CMRs #4 to #7 correspond to TRP #2 (for the multi TRP). As the CSI pairs for the multi TRP, the 4 or 16 CSI pairs shown in one of the options of the first embodiment/second embodiment may be configured. Next, CMRs #a and #b corresponding to two beams (CSIs) for TRP #1 (for the single TRP) are configured, and subsequently CMRs #c and #d corresponding to two beams (CSIs) for TRP #2 (for the single TRP) are configured.

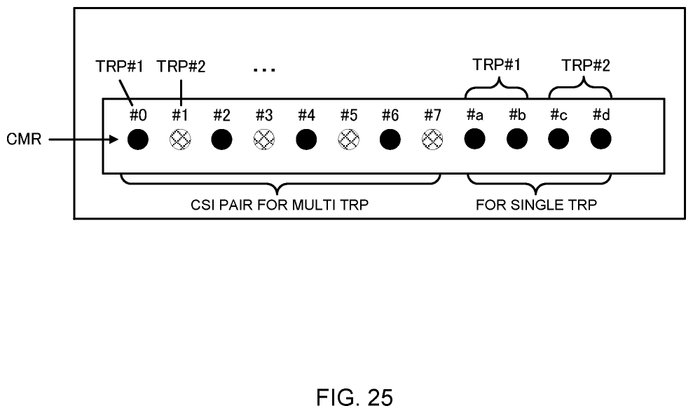

FIG. 25 is a diagram to show a second configuration example of the CMRs in option 4-1-1 of the fourth embodiment. As shown in FIG. 25, CMRs #0, #2, #4, and #6 correspond to TRP #1 (for the multi TRP), and CMRs #1, #3, #5, and #7 correspond to TRP #2 (for the multi TRP). As the CSI pairs for the multi TRP, a pair of CMRs #0 and #1, a pair of CMRs #2 and #3, a pair of CMRs #4 and #5, and a pair of CMRs #6 and #7 may each be configured. Next, CMRs #a and #b corresponding to two beams (CSIs) for TRP #1 (for the single TRP) are configured, and subsequently CMRs #c and #d corresponding to two beams (CSIs) for TRP #2 (for the single TRP) are configured.

### [Option 4-1-2]

The CMRs (M CMRs per TRP) for the single TRP may be configured first, and the CMRs (N beam pairs) for the multi TRP may be configured subsequently. M and N may be configured using higher layer signaling or the like, for example.

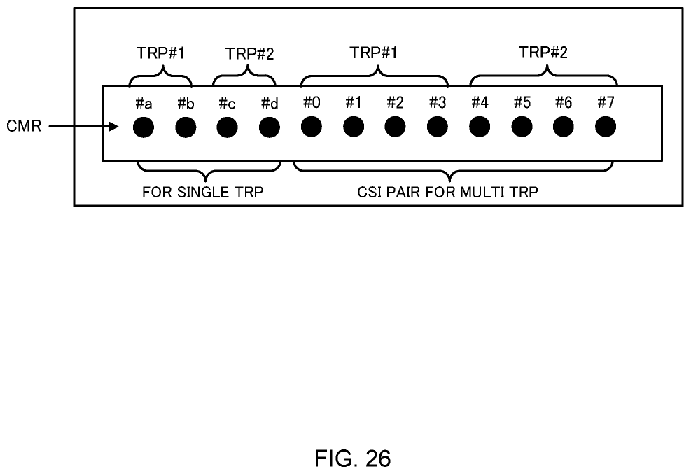

FIG. 26 is a diagram to show a first configuration example of the CMRs in option 4-1-2 of the fourth embodiment. FIG. 26 is the same as the example of FIG. 24 except that the order of CMRs #0 to #7 (for the multi TRP) and CMRs #a to #d (for the single TRP) is interchanged, and thus detailed description will be omitted.

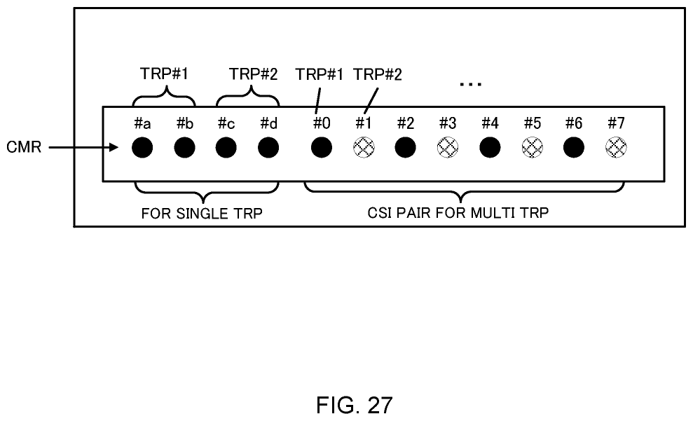

FIG. 27 is a diagram to show a second configuration example of the CMRs in option 4-1-2 of the fourth embodiment. FIG. 27 is the same as the example of FIG. 25 except that the order of CMRs #0 to #7 (for the multi TRP) and CMRs #a to #d (for the single TRP) is interchanged, and thus detailed description will be omitted.

In the CRI report, order of the CRI indexes for the single TRP and the CSI indexes for the multi TRP may be interchanged. The CRI indexes may be configured as shown in the following option 4-1-3 or option 4-1-4, or may be determined in a specification in advance as shown in these options, for example.

### [Option 4-1-3]

CRI k (k≥0) corresponds to a (k+1)-th CSI pair. The CRIs for TRP #1 start from 2N, and the CRIs for TRP #2 start from 2N+M. N is the number of CMR resources for each TRP. In other words, the CSIs for the multi TRP may correspond to CRI indexes 0 to N−1, and the CSIs for the single TRP may correspond to CRI index 2N or greater.

### [Option 4-1-4]

CRI k (k≥0) corresponds to TRP #1 (single TRP), the CRIs for TRP #2 (single TRP) start from M, and the CRIs for the multi TRP start from 2M. In other words, the CSIs for the single TRP may correspond to CRI indexes 0 to M−1, and the CSIs for the multi TRP may correspond to CRI index 2M or greater.

### [Option 4-2]

The IMR resources of the single TRP hypothesis may be additionally configured, or may be specific to the TRP. The IMR resources of the single TRP hypothesis may be different from the IMR resources of the multi TRP hypothesis. Order of the IMRs for the single TRP and the IMRs for the multi TRP may be interchanged. Note that the order of the IMR resources is the same as the order of the CMRs corresponding to the single TRP and the multi TRP. One-to-one mapping between the CMRs and the IMRs of the single TRP hypothesis is performed as in the following option 4-2-1 or option 4-2-2, for example.

### [Option 4-2-1]

The CSI-IMs/NZP-IMRs corresponding to the multi TRP may be configured first, and the CSI-IMs/NZP-IMRs corresponding to the single TRP may be configured subsequently. For the CSI-IMs/NZP-IMRs, TRP #1 may be configured first, and TRP #2 may be configured subsequently.

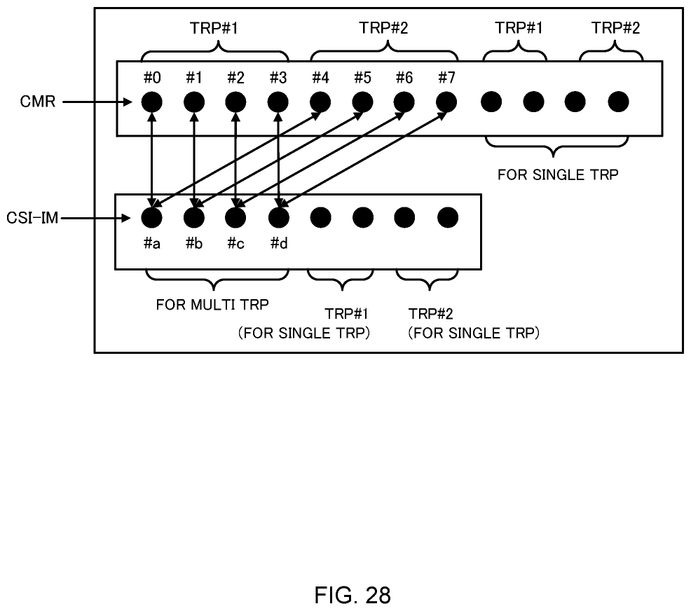

FIG. 28 is a diagram to show a configuration example of the CMRs/CSI-IMs in option 4-2-1 of the fourth embodiment. FIG. 28 presupposes option 1-1 of the first embodiment. Description of similarities to option 1-1 will be omitted. In FIG. 28, the configuration of the CMRs is the same as that of FIG. 24. In the configuration of the CSI-IMs, the CSI-IMs corresponding to the multi TRP are configured first, and the CSI-IMs corresponding to TRP #1 (for the single TRP) and the CSI-IMs corresponding to TRP #2 (for the single TRP) are configured subsequently successively. Note that the configuration of the NZP-IMRs may be similar to the configuration of the CSI-IMs as well.

### [Option 4-2-2]

The CSI-IMs/NZP-IMRs corresponding to the single TRP may be configured first, and the CSI-IMs/NZP-IMRs corresponding to the multi TRP may be configured subsequently. For the CSI-IMs/NZP-IMRs, TRP #1 may be configured first, and TRP #2 may be configured subsequently.

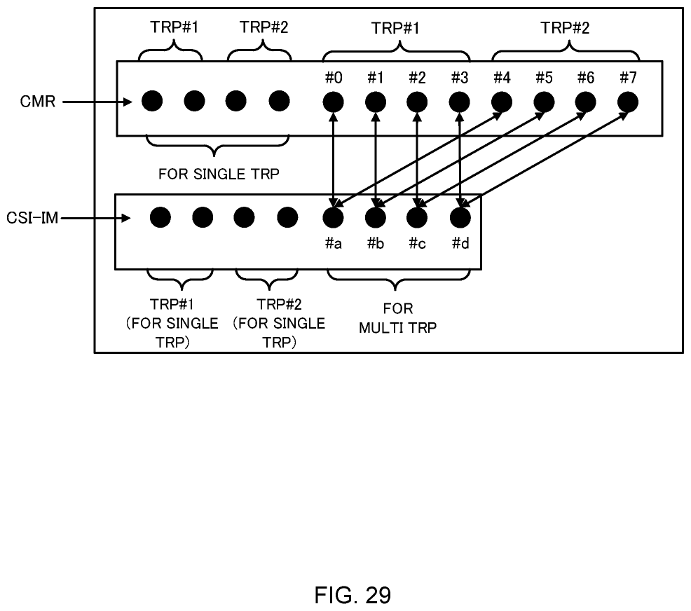

FIG. 29 is a diagram to show a configuration example of the CMRs/CSI-IMs in option 4-2-2 of the fourth embodiment. FIG. 29 presupposes option 1-1 of the first embodiment. Description of similarities to option 1-1 will be omitted. In FIG. 29, the configuration of the CMRs is the same as that of FIG. 26. In the configuration of the CSI-IMs, the CSI-IMs corresponding to TRP #1 (for the single TRP) and the CSI-IMs corresponding to TRP #2 (for the single TRP) are configured first successively, and the CSI-IMs corresponding to the multi TRP are configured subsequently. Note that the configuration of the NZP-IMRs may be similar to the configuration of the CSI-IMs as well.

Option 4-2-1 and option 4-2-2 presuppose option 1-1 of the first embodiment, but may presuppose other options of the first embodiment and the second embodiment.

According to the fourth embodiment, a joint method for measurement/report in the multi panel/TRP hypothesis and measurement/report in the single panel/TRP hypothesis is clarified.

### Fifth Embodiment

When a joint CSI report corresponding to (or including) the best CSI for the multi TRP and the best CSI/second best CSI from each TRP (two TRPs) for the single TRP is configured, the CMR resources measured by the UE as the CSI pairs for the multi TRP are measured by the UE for an individual single TRP hypothesis (which may be referred to as a presupposition or an assumption).

The UE may assume both of an assumption for the multi TRP and an assumption for the single TRP regarding the IMR resources. In other words, the IMR resources may be used in common for both of measurement for the multi TRP and measurement for the single TRP. Independent CMR/IMR configurations for the single TRP and the multi TRP are not performed. Note that UE measurement operations for the single TRP and the multi TRP are different. In the present embodiment, the example of option 3-1 may be applied to the CMR resource configuration and the CRI report. Regarding assumptions of IMR measurement, the following option 5-1 and 5-2 may be applied.

### [Option 5-1]

The UE may assume that the CSI-IMs (ZP-IMRs) mean interference outside both of the TRPs (interference from other than both of the TRPs). This corresponds to interference for the multi TRP assumption. When the UE derives the CSIs for the single TRP, the UE may recalculate the interference from other TRPs, and use the interference after adding the interference to the interference from other than both of the TRPs.

### [Option 5-2]

The UE may assume that the CSI-IMs (ZP-IMRs) associated with each TRP mean interference outside a corresponding TRP (interference from other than a corresponding TRP). This corresponds to interference for the single TRP assumption. Next, when the UE derives the CSIs for the multi TRP, the UE may recalculate the interference from other TRPs, and use the interference after subtracting the interference from the interference from other than the corresponding TRP.

### Sixth Embodiment

A sixth embodiment relates to a restriction on the beam pairs. The restriction on the beam pairs to be described in the sixth embodiment (or a determination/selection/configuration method of the beam pairs with the restriction being taken into consideration) may be simply referred to as a beam pairing method. The beam pair in the present disclosure may be interchangeably interpreted as a CMR pair. The CMR pair may mean a pair of CMRs measured as the CSI pair for a plurality of TRPs.

The inventors of the present invention found out that there is a case in which the UE may not be able to efficiently measure the beam pairs considering interference between beams (or TRPs) depending on a configuration of resources regarding the beam pairs as described above.

In the present disclosure, in FR2, the UE assumes that the UE can perform measurement by simultaneously using a plurality of receive beams. In this case, the UE may measure signals by assuming that one receive beam is formed per at least one panel (in other words, one receive beam corresponds to at least one panel). The UE may not be able to measure signals by assuming a plurality of receive beams for one panel. The UE operating in FR2 may include a certain number of (for example, two) panels.

In the present disclosure, in FR1, the UE assumes that the UE can perform measurement by simultaneously using up to one receive beam. The UE may include one receive beam, or may not include receive beams.

The following description assumes that the above-described assumption is applied in FR1/2 of the present disclosure, but this is not restrictive. FR1/2 in the following description may be interpreted in a case in which the above-described assumption is applied in the frequency band other than FR1/2.

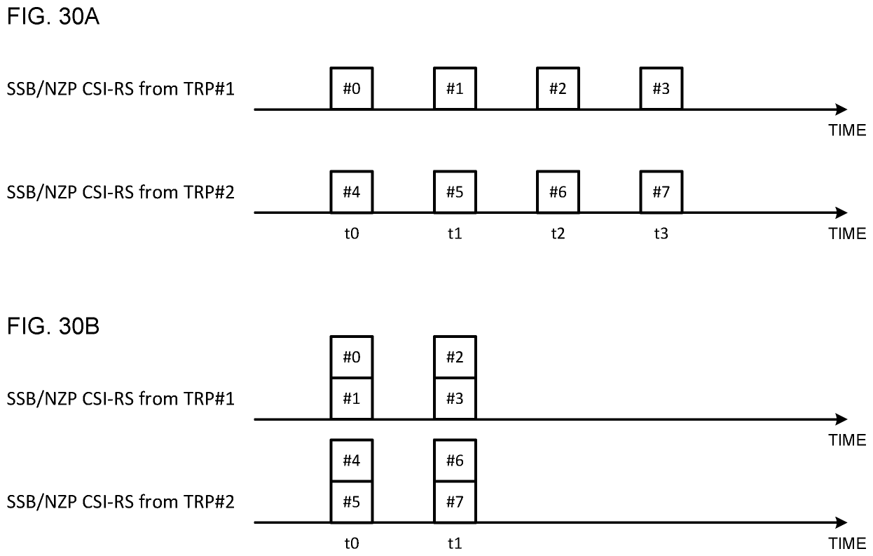

FIGS. 30A and 30B are each a diagram to show an example of a problem in measurement of beam pairs. Description of the present example takes an example of a case in which the CMRs (SSB IDs/CSI-RS resource IDs) #0 to #3 correspond to the SSBs/NZP CSI-RSs from TRP #1 and CMRs #4 to #7 correspond to the SSBs/NZP CSI-RSs from TRP #2 as shown in FIG. 4.

FIG. 30A shows an example in which the time resources of CMRs #0 and #4 correspond to time to, the time resources of CMRs #1 and #5 correspond to time t1, the time resources of CMRs #2 and #6 correspond to time t2, and the time resources of CMRs #3 and #7 correspond to time t3.

When it is assumed that FIG. 30A shows a configuration of FR2, the UE can measure a beam pair of CMRs #0 and #4 (hereinafter simply expressed as a beam pair (0, 4)) in to, a beam pair (1, 5) in t1, a beam pair (2, 6) in t2, and a beam pair (3, 7) in t3. In contrast, the UE cannot measure other beam pairs (for example, a beam pair (0, 5)).

When it is assumed that FIG. 30A shows a configuration of FR1 regarding inter-TRP interference measurement, the UE cannot directly measure beam pairs other than the four beam pairs described above (the beam pairs (0, 4), (1, 5), (2, 6), and (3, 7)) for inter-TRP interference measurement. In contrast, the UE may recalculate each pair regarding inter-TRP interference in FR1.

FIG. 30B shows an example in which the time resources of CMRs #0, #1, #4, and #5 correspond to time to, and the time resources of CMRs #2, #3, #6, and #7 correspond to time t1.

When it is assumed that FIG. 30B shows a configuration of FR2, the UE may measure one beam pair (for example, the beam pair (0, 4)) in to with the restriction on reception described above, and measure one beam pair (for example, the beam pair (2, 6)) in t1. In contrast, the UE cannot measure other beam pairs (for example, a beam pair (0, 5)).

When it is assumed that FIG. 30B shows a configuration of FR1 regarding inter-TRP interference measurement, the UE can measure four beam pairs (beam pairs (0, 4), (0, 5), (1, 4), and (1, 5)) in to and measure four beam pairs (beam pairs (2, 6), (2, 7), (3, 6), and (3, 7)) in t1 for inter-TRP interference measurement.

As described with reference to FIGS. 30A and 30B, in FR2, it may be assumed that, in time for measuring a beam pair to which a certain CMR belongs, the UE cannot measure another beam pair to which the CMR belongs (by using a beam different from that for measurement of the beam pair). In FR1, it may be assumed that, in time for measuring a beam pair to which a certain CMR belongs, the UE can measure another beam pair to which the CMR belongs.

As in FIG. 30A, a plurality of CMRs from a certain TRP may be subjected to TDM, and as in FIG. 30B, a plurality of CMRs from a certain TRP may be subjected to TDM/FDM.

The inventors of the present invention came up with the idea of a beam pairing method for reducing cases in which the UE cannot efficiently measure the beam pairs (options 6-1 to 6-3 below).

### [Option 6-1]

Option 6-1 corresponds to a one-to-one-to-one beam pairing method from two TRPs for at least one of the group based L1 beam report (for example, group based L1-RSRP report) and the CSI report. The one-to-one beam pairing method is applied to N one-to-one CSI pairs as shown in FIGS. 4 to 5, for example.

In the following options 6-1-1 to 6-1-3, one or more restrictions may be considered in the CMR configuration. In other words, the UE may assume that there are one or more restrictions in the following options 6-1-1 to 6-1-3.

A restriction that an ID of one SSB/NZP-CSI-RS is configured (used) in only one beam pair (CMR pair) may be applied (option 6-1-1). In other words, when a certain CMR ID is configured in a certain beam pair, the UE does not expect that the CMD ID is configured in another beam pair.

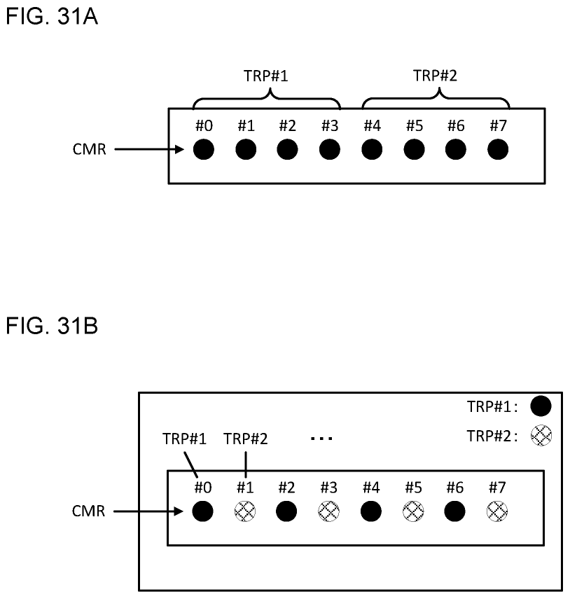

FIGS. 31A and 31B are each a diagram to show a configuration example of the CMRs in option 6-1-1 of the sixth embodiment.

FIG. 31A shows an example in which CMRs #0 to #3 correspond to the SSBs/NZP CSI-RSs from TRP #1, and CMRs #4 to #7 correspond to the SSBs/NZP CSI-RSs from TRP #2. When N (for example, four) beam pairs are configured for the group based beam report or the MTRP CSI report, provided that a first pair corresponds to CMRs #0 and #4, a configuration that these CMRs #0 and #4 are not included in other three pairs is performed.

FIG. 31B shows an example in which CMRs #0, #2, #4, and #6 correspond to the SSBs/NZP CSI-RSs from TRP #1, and CMRs #1, #3, #5, and #7 correspond to the SSBs/NZP CSI-RSs from TRP #2. When N (for example, four) beam pairs are configured for the group based beam report or the MTRP CSI report, provided that a first pair corresponds to CMRs #0 and #1, a configuration that these CMRs #0 and #1 are not included in other three pairs is performed.

A restriction of being subjected to TDM with the same periodicity may be applied to one or a plurality of CMRs configured from one TRP (regarding one TRP) (option 6-1-2). In other words, it may be assumed that, regarding one or a plurality of CMRs configured from one TRP, information that configuration information of the periodicity and offset of the CSI-RS resources (for example, an RRC parameter “CSI-ResourcePeriodicityAndOffset”) has only a different offset and has the same periodicity is configured.

Regarding two beams (CMRs) configured explicitly or implicitly in each beam pair, a restriction that the two CMRs are configured with the same time behavior and the same time slot (for example, the same periodicity and the same offset) may be applied (option 6-1-3). Note that the time behavior may be at least one of periodic, semi-persistent, and aperiodic.

Note that the above restrictions of option 6-1-1 and option 6-1-3 may be applied to only FR2, may be applied to CSI measurement for group based L1-SINR measurement/MTRP, or may be applied when there is a corresponding UE capability. The above restrictions of options 6-1-1 and option 6-1-3 need not be applied to L1-RSRP measurement in FR1.

Note that the above restriction of option 6-1-2 may be applied to only FR2, or may be applied when there is a corresponding UE capability.

### [Option 6-2]

Option 6-2 corresponds to an N×N beam pairing method from two TRPs for at least one of the group based L1 beam report (for example, group based L1-RSRP report) and the CSI report. The N×N beam pairing method is applied to N×N CSI pairs as shown in FIGS. 6 to 7, for example.

One or more restrictions described below may be taken into consideration in the CMR configuration. In other words, the UE may assume that there are one or more restrictions described below.

For the CMRs for the group based beam report/MTRP CSI report, repetition may be permitted to be configured ‘on’. Repetition of the CMRs being configured ‘on’ may be configured as information related to repetition regarding the NZP CSI-RS resource set or the NZP CSI-RS resources corresponding to the CMRs, for example. The information related to repetition may indicate ‘on’ or ‘off’, for example. Note that ‘on’ may be expressed as ‘enabled’ or ‘valid’, and ‘off’ may be expressed as ‘disabled’ or ‘invalid’.

For example, regarding the CMRs whose repetition is configured ‘on’, the UE may assume that the CMRs in different times are transmitted using the same downlink spatial domain transmission filter. In this case, the UE may assume that the CMRs are transmitted using the same beam (for example, using the same beam from the same TRP).

Regarding the CMRs whose repetition is configured ‘off’, the UE may perform control that the UE must not assume (or may not assume) that the CMRs in different times are transmitted using the same downlink spatial domain transmission filter. In this case, the UE may assume that the CMRs are not transmitted using the same beam (transmitted using different beams). In other words, regarding the CMRs whose repetition is configured ‘off’, the UE may assume that the TRP performs beam sweeping.

The number of repetitions (the number of repetition transmissions) of the CMRs may be determined in a specification in advance, may be configured for the UE by higher layer signaling (for example, RRC signaling, MAC CE), or may be determined based on a UE capability. When the number of repetition of the CMRs is not explicitly configured, the UE may derive the number of repetitions of the CMRs, based on the number of configured or corresponding IMRs. The number of IMRs may correspond to the number of CMRs for another TRP.

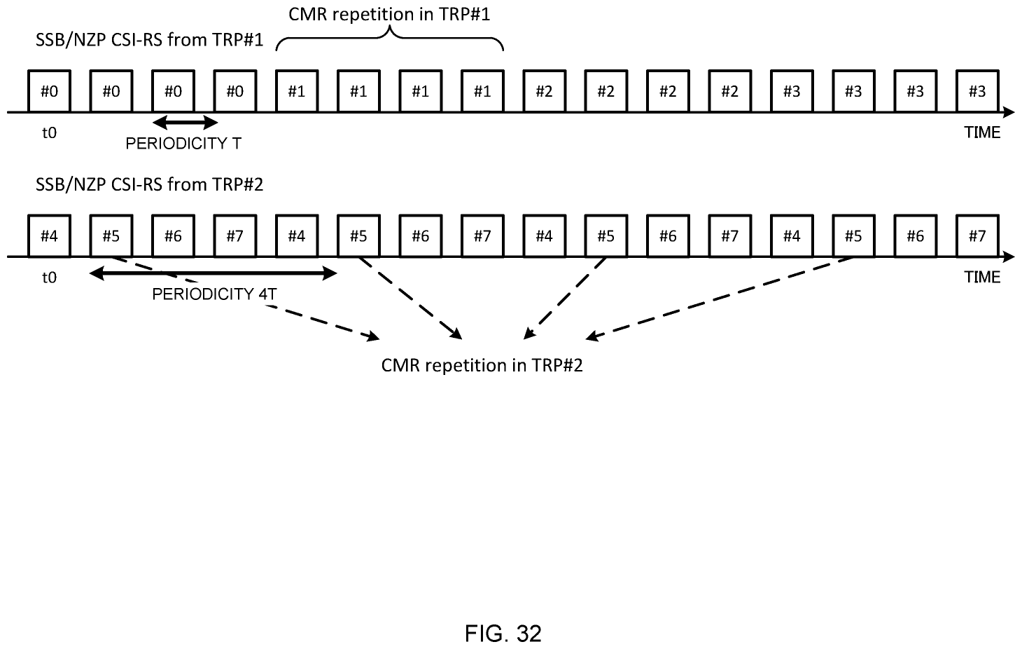

FIG. 32 is a diagram to show a configuration example of the CMRs in option 6-2 of the sixth embodiment.

In the present example, for each of CMRs #0 to #3 corresponding to the SSBs/NZP CSI-RSs from TRP #1, four repetitions as the number of repetitions are configured on. For each of CMRs #4 to #7 corresponding to the SSBs/NZP CSI-RSs from TRP #2, four repetitions as the number of repetitions are configured on.

In FR2, or by considering inter-beam interference, the UE may assume that N× N (for example, N=4) beam pairs as in FIG. 32 are to be configured. The UE can simultaneously measure the CMRs (for example, CMRs #0 and #4) of beam pairs in the same time.

In the present example, in a period in which repetition of the CMRs for TRP #1 is performed, the CMRs for other TRP #1 are configured not to repeat. For example, CMR #0 is transmitted four times from time to with periodicity T, and CMR #1 is transmitted four times from time t0+4T with periodicity T.

In the present example, during a repetition period of the CMRs for TRP #2, a part of the CMRs for other TRP #2 is configured to be present. For example, CMR #4 is transmitted four times from time to with periodicity 4T, and CMR #5 is transmitted four times from time t0+T with periodicity 4T.

Regarding the CMRs whose repetition is configured ‘on’, configuration of an offset of the repetition period/repetition start timing (hereinafter also simply referred to as a repetition offset) may be supported. As shown in FIG. 32, the repetition period/offset may be different for each TRP. A value of the repetition period/offset may be determined in a specification in advance (for example, a gap of two symbols), may be configured for the UE by higher layer signaling (for example, RRC signaling, MAC CE), or may be determined based on a UE capability. The value of the repetition period/offset may be defined/configured/determined to be different for each subcarrier spacing.

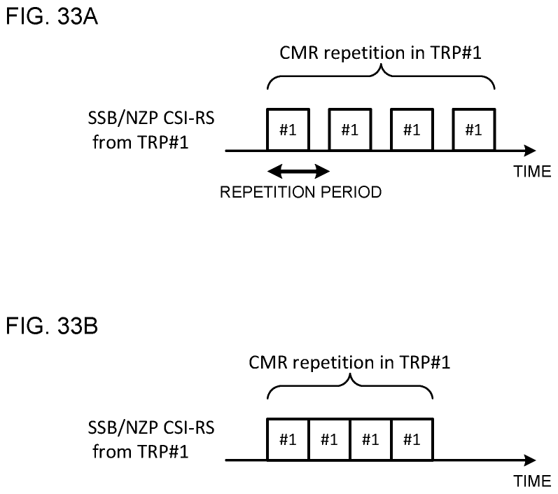

FIGS. 33A and 33B are each a diagram to show an example of repetition of the CMRs in option 6-2 of the sixth embodiment. As in FIG. 33A, the repetition period may be such a value that has a gap between repetitions. The repetition period may be longer than time (for example, one or more symbols, or one or more slots) to which the CMRs per repetition are allocated. The repetition period may be represented by a gap from an end symbol of a certain repetition to a start symbol of a subsequent repetition, or may be represented by a gap (periodicity) from a start symbol of a certain repetition to a start symbol of a subsequent repetition.

As in FIG. 33B, the repetition period may be such a value that does not have a gap between repetitions (repetitions are performed in consecutive symbols). In this case, the repetition period may be the same as time to which the CMRs per repetition are allocated, or may be configured as repetition period=0. When the repetition period of the CMRs is not configured, the UE may assume that the repetition without gaps as in FIG. 33B is applied to the CMRs.

The value of the repetition period/offset of the CMRs may be configured by configuration information (for example, the RRC parameter “CSI-ResourcePeriodicityAndOffset”) of the periodicity and the offset of the CSI-RS resources, or may be configured using another parameter.

Note that the above restrictions of option 6-2 may be applied to only FR2, may be applied to CSI measurement for group based L1-SINR measurement/MTRP, or may be applied when there is a corresponding UE capability. Whether the configuration of the repetition period/offset can be supported or not may be dependent upon a UE capability. The UE may report, to the network, the information as to whether the support can be performed or not, the information related to the value of the repetition period/offset supported, and the like as UE capability information.

### [Option 6-3]

Different beam pairing methods (the beam pairing method of option 6-1 and the beam pairing method of option 6-2) may be assumed by the UE by considering different measurement purposes configurations, or may be supported and configured by the network by considering different measurement purposes.

For example, the one-to-one beam pairing method of option 6-1 may be supported/assumed/applied/configured regarding only FR2. The one-to-one beam pairing method of option 6-1 may be supported/assumed/applied/configured regarding CSI measurement for group based L1-SINR measurement/MTRP.

For example, the N×N beam pairing method of option 6-2 may be supported/assumed/applied/configured regarding only FR1. The one-to-one beam pairing method of option 6-1 may be supported/assumed/applied/configured regarding only group based L1-RSRP measurement in FR1.

Note that the “group based beam report” in the present disclosure may be interchangeably interpreted as group based beam measurement, group based beam measurement/report, group based L1 measurement/report, and the like. The “MTRP CSI report” in the present disclosure may be interchangeably interpreted as MTRP CSI measurement, CSI measurement/report for MTRP, and the like. The “resource” in the present disclosure may be interchangeably interpreted as a resource set, a resource group, and the like.

### Seventh Embodiment

A seventh embodiment relates to a configuration of the beam pairs in which a CMR group corresponding to the TRP is used and a CRI report method.

### [Option 7-1]

Option 7-1 relates to a configuration regarding the CMR group.

For at least one of the group based beam report and the CSI report, the UE may be configured with two CMR groups (a first CMR group and a second CMR group). The first CMR group includes K1 CMRs, and the second CMR group includes K2 CMRs. K1+K2=Ks.

The UE may be configured with one or a plurality of pieces of CMR group configuration information by RRC signaling. One piece of CMR group configuration information may include information indicating the CMRs included in one CMR group (in other words, may correspond to one TRP), or may include information indicating the CMRs respectively included in a plurality of CMR groups (in other words, may correspond to a plurality of TRPs).

The UE may be configured with information regarding to which CMR group the CMRs belong by RRC signaling. In this case, the UE can determine the CMRs included in the CMR group even without the CMR group configuration information as described above.

Note that K1 and K2 may be the same value, or may be different values. Two CMR groups may respectively correspond to two TRPs of MTRP, or one of them may correspond to MTRP and the other may correspond to STRP.

The CMRs used for the CSI measurement/report from two CMR groups may be determined by at least one of the following:
determined in a specification in advance. For example, all of the CMRs of K1 and K2 may be used for both of hypotheses of NCJT (MTRP) and STRP measurement.
configured/updated by at least one of RRC and MAC CE.

Note that, in the present disclosure, NCJT, MTRP, MTRP measurement, an MTRP hypothesis, an MTRP measurement hypothesis, and the like may be interchangeably interpreted as each other.

It may be indicated that first M1 CMRs of K1 CMRs and first M2 CMRs of K2 CMRs are used for NCJT. In this case, the rest of the CMRs (=Ks−M1−M2 CMRs) may be used for STRP measurement, and all of the CMRs (=Ks CMRs) may be used for STRP measurement. Note that M1 and M2 may be the same value, or may be different values.

Note that, in the present disclosure, “first”, “last”, “first/last”, “even-numbered (in other words, a corresponding entry is an even-numbered entry or an index is an even number)”, “odd-numbered (in other words, a corresponding entry is an odd-numbered entry or an index is an odd number)”, “even-numbered/odd-numbered”, and the like may be interchangeably interpreted as each other.

It may be indicated that first M CMRs of Ks CMRs are used for NCJT. In this case, the rest of the CMRs (=Ks−M CMRs) may be used for STRP measurement, and all of the CMRs (=Ks CMRs) may be used for STRP measurement.

For indication as to whether each CMR is for NCJT or for STRP, a bitmap of K1+K2 bits (indication is 1 bit) may be used, or a bitmap of 2*(K1+K2) bits (indication is 2 bits) may be used. Note that, for these indications of the first CMR group, a bitmap of K1 or 2*K1 bits may be used. For these indications of the second CMR group, a bitmap of K2 or 2*K2 bits may be used.

The determination/assumption/application/configuration as to which of the NCJT (MTRP) and STRP measurement hypotheses the CMRs are used as described in option 7-1 may be different depending on different measurement purposes (for example, L1 group based beam measurement, CSI measurement, L1-RSRP measurement, L1-SINR measurement), different frequency ranges (for example, FR1, FR2), or the like.

Note that, regarding at least one of a specific measurement purpose (for example, group based L1-RSRP measurement) and a specific frequency domain (for example, FR2), the restrictions on the CMR configuration described in the sixth embodiment may be applied. For example, in FR2, a restriction that the CMRs configured for NCJT measurement is not configured/assumed for STRP measurement may be applied.

According to option 7-1 described above, the UE can appropriately determine the configuration regarding the CMR groups.

### [Option 7-2]

In option 7-2, for at least one of the group based beam report and the CSI report, CMR pairing information for the NCJT measurement hypothesis regarding two CMR groups is additionally configured/updated for the UE by RRC/MAC CE/DCI.

The following will describe a case in which M1 CMRs for NCJT are defined/configured/assumed for the first CMR group and M2 CMRs for NCJT are defined/configured/assumed for the second CMR group according to option 7-1. As described above, M1≤K1 and M2≤K2 may hold.

The CMR pairing information may be a bitmap of M1*M2 bits (indication is 1 bit; for example, ‘1’ means valid/enabled, and ‘0’ means disabled/invalid). Each indication of 1 bit indicates whether or not a specific CMR pair from two CMR groups is enabled (in other words, can be used for NCJT). The UE may use only the CMR pairs indicated as enabled for NCJT measurement.

The CMR pairs (which may be referred to as CMR pairing positions) corresponding to respective bits of the bitmap may be determined in a specification in advance. For example, the CMR pairs corresponding to respective bits may be determined in accordance with a rule (in other words, first CMR group first and second CMR group second) in which the CMRs of the first CMR group are arranged in an index ascending order (or descending order), and regarding the indexes of the CMRs of the same first CMR group, the CMRs of the second CMR group are arranged in an index ascending order (or descending order). Conversely, a rule of second CMR group first and first CMR group second may be adopted.

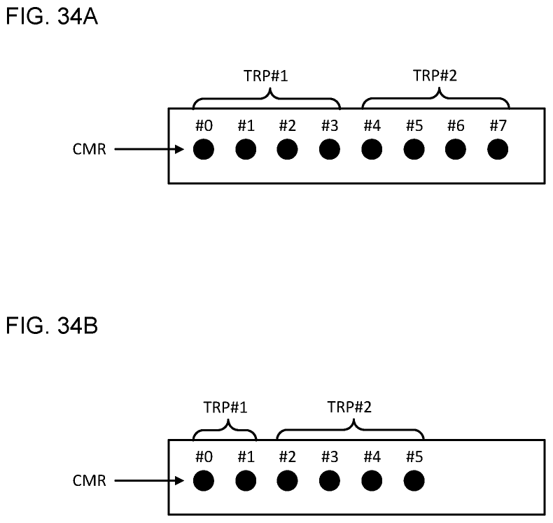

FIGS. 34A and 34B are each a diagram to show a configuration example of the CMRs in option 7-2 of the seventh embodiment.

FIG. 34A shows a case regarding the CMRs for NCJT in which CMRs #0 to #3 are configured/assumed as the first CMR group (corresponding to the CMRs for TRP #1), and CMRs #4 to #7 are configured/assumed as the second CMR group (corresponding to the CMRs for TRP #2). In this case, M1=M2=4, and as the CMR pairing information, a bitmap of M1*M2 (=16) bits may be used.

Regarding a bitmap of 16 bits related to the CMR configuration of FIG. 34A, the CMR pairs indicated by respective bit positions may be one of the following, for example:
In a case of first CMR group first: (0,4), (0,5), (0,6), (0,7), (1,4), (1,5), (1,6), (1,7), (2,4), (2,5), (2,6), (2,7), (3,4), (3,5), (3,6), (3,7).
In a case of second CMR group first: (0,4), (1,4), (2,4), (3,4), (0, 5), (1, 5), (2, 5), (3, 5), (0, 6), (1, 6), (2, 6), (3, 6), (0, 7), (1,7), (2,7), (3,7).

For example, when the CMR pairing positions of first CMR group first are adopted, and the bitmap indicates “1100100000000000”, the UE may assume that three CMR pairs (0,4), (0,5), and (1,4) can be used for measurement for NCJT.

FIG. 34B shows a case regarding the CMRs for NCJT in which CMRs #0 to #1 are configured/assumed as the first CMR group (corresponding to the CMRs for TRP #1), and CMRs #2 to #5 are configured/assumed as the second CMR group (corresponding to the CMRs for TRP #2). In this case, M1=2 and M2=4, and as the CMR pairing information, a bitmap of M1*M2 (=8) bits may be used.

The CMR pairing information is not limited to the bitmap of M1*M2 bits. For example, the CMR pairing information may be a matrix (layout) including M2 (or M1) columns each including M1 (or M2) bits. When a set of one or more CMR pairs is configured for the UE by RRC signaling, the CMR pairing information may be information (for example, an index) indicating at least one of these, or may be reported by MAC CE/DCI.

The CMR pairing information may be explicitly reported by a specific field (for example, a CMR pairing information field) in DCI, or may be implicitly reported by another field. For example, the CMR pairing information may be associated with a trigger state (or an ID (CSI-AperiodicTriggerStateId) of the trigger state) configured using a higher layer parameter “CSI-AperiodicTriggerState”. In this case, different code points (different values) of a CSI request field in the DCI may indicate different pieces of CMR pairing information.

Note that, regarding at least one of a specific measurement purpose (for example, group based L1-RSRP measurement) and a specific frequency domain (for example, FR2), the restrictions on the CMR configuration described in the sixth embodiment may be applied. For example, in FR2, a restriction that the CMRs configured for the beam pairs for NCJT measurement are not configured for other beam pairs for NCJT measurement may be applied. With such a restriction being taken into consideration, as the CMR pairing information, a bitmap shorter than the above-described bitmap may be used.

The shorter bitmap may include a first bit string and a second bit string. The first bit string may indicate whether or not each CMR resource in a certain CMR group is valid for CMR pairing (or NCJT). The number of bits of the first bit string may be a minimum or maximum number of bits out of M1 and M2. The certain CMR group may mean the first CMR group when the number of bits of the first bit string=M1, otherwise the certain CMR group may mean the second CMR group.

The second bit string may indicate whether or not each of M2 (or M1) CMRs not indicated in the first bit string constitutes a CMR pair with each of the CMR resources indicated as valid in the first bit string. The number of bits of the second bit string may be X*M2 or X*M1, provided that the number of CMR resources indicated as valid in the first bit string is represented by X.

In other words, the number of bits of the shorter bitmap may be M1+X*M2 or M2+X*M1.

Description will be given with reference to the example shown in FIG. 34B in which CMRs #0 to #1 are configured/assumed as the first CMR group (corresponding to the CMRs for TRP #1) and CMRs #2 to #5 are configured/assumed as the second CMR group (corresponding to the CMRs for TRP #2). In this case, M1=2 and M2=4.

When a short bitmap of M1+X*M2 bits is used as the CMR pairing information of FIG. 34B, for example, the first bit string (M1=2 bits) included in the bitmap may be “01” (only #1 is valid in the first CMR group, in other words, indicates that X=1), and the second bit string (X*M2=4 bits) may be “0100” (indicates that, in the second CMR group, #3 constitutes a CMR pair with #1).

When the shorter bitmap of M2+X*M1 bits is used as the CMR pairing information of FIG. 34B, for example, the first bit string (M2=4 bits) included in the bitmap may be “0110” (#3 and #4 are valid in the second CMR group, in other words, indicates that X=2), and the second bit string (X*M1=4 bits) may be “1001” (indicates that, in the first CMR group, #0 constitutes a CMR pair with #3, and in the first CMR group, #1 constitutes a CMR pair with #4).

Note that, in the second bit string, i-th (i is 1 or greater) X bits may indicate information as to whether or not to constitute a CMR pair with the CMR resource corresponding to an i-th smallest (or largest) index of the CMR resources indicated as valid in the first bit string.

Note that a maximum value of the number (for example, V) of valid CMR pairs (beam pairs) from two CMR groups may be determined in a specification in advance, or may be determined based on a UE capability. The UE may assume that the number of valid CMR pairs indicated by the CMR pairing information does not exceed the maximum number.

According to option 7-2 described above, for example, by using the CMR pairing information, adjustments that the CMRs once configured/assumed for measurement for NCJT based on option 7-1 are arranged not to be used for NCJT measurement or not to be used for NCJT measurement again can be suitably performed.

### [Option 7-3]

Option 7-3 relates to the CRI indexes of report for CMR beam pairs for the valid CMR pairs as shown in option 7-2. The CRI indexes are sufficient if (V) valid CMR pairs can be expressed instead of the number (M1*M2) of all of configured/assumed CMR beam pairs.

When the report of the STRP hypothesis (in other words, the report for STRP) is not configured for the UE or when the report of the STRP hypothesis is reported after NCJT, the reported CRI indexes may have a value of 0 or greater and V−1 or less, which can represent valid CMR pairs.

When the report of the STRP hypothesis corresponds to the indexes of a value of 0 or greater and S−1 or less, the CRI indexes reported for NCJT may have a value of S or greater and S+V−1 or less, which can represent valid CMR pairs.

The CRI indexes corresponding to the valid CMR pairs may be indexed again in accordance with a certain rule (for example, may be provided with a value from 0). For example, the CRI indexes corresponding to the valid CMR pairs may be indexed in order of the CMRs arranged in ascending order or descending order along first CMR group first (and second CMR group second) described above, or may be indexed in order of the CMRs arranged in ascending order or descending order along second CMR group first (and first CMR group second) described above.

For example, when only two valid beam pairs are indicated out of M1*M2 beam pairs according to the bitmap of option 7-2, CRI=0 may represent one valid beam pair of the two, and CRI=1 may represent the other valid beam pair of the two.

For example, when K1+K2 CMRs are used for the STRP hypothesis, the CRI indexes for the STRP CSI report may have a value of 0 or greater and K1+K2−1, and the CRI indexes for the NCJT CSI report may have a value of K1+K2 or greater and K1+K2+V−1.

For example, when K1+K2-M1-M2 CMRs are used for the STRP hypothesis, the CRI indexes for the STRP CSI report may have a value of 0 or greater and K1+K2-M1-M2-1 or less, and the CRI indexes for the NCJT CSI report may have a value of K1+K2−M1−M2 or greater and K1+K2−M1−M2+V−1.

According to option 7-3 described above, even when the CMR groups are introduced, the CRIs can be suitably reported.

### <UE Capability>

The UE may transmit (report), to the base station, at least one of the following (1) to (16) as the UE capability (UE capability information).

(1) in the CSI configuration, whether to support the CMRs from different TRPs.
(2) in the CSI configuration, whether to support the CSI-IM resources (ZP-IMRs)/NZP-CSI-RS resources (NZP-IMRs) for interference measurement for different TRPs.
(3) whether to support one or two CRIs for the CSI pair including two CSIs for the MTRP NCJT CSI report.
(4) in the periodic/semi-persistent/aperiodic CSI, whether to support interference measurement for one TRP based on the CMRs from another TRP.
(5) whether to support assumption of calculated precoding applied to the CMRs when the UE measures interference based on the CMRs.
(6) in the CSI report, whether to support report of both of one best CSI for the single TRP and one best CSI for the multi TRP.
(7) in the CSI report, whether to support report of two best CSIs (one CSI for each TRP) for the single TRP and one best CSI for the multi TRP.
(8) in the CSI report, whether to support report of two best CSIs (one CSI for each TRP) for the single TRP.
(9) in the CSI report, whether to support report of one CSI (selected by the UE) from the best CSI for the single TRP and the best CSI for the multi TRP.
(10) for the single TRP assumption and the multi TRP assumption, whether to support independent/separate CMR resource configuration.
(11) for the single TRP assumption and the multi TRP assumption, whether to support independent/separate IMR (CSI-IM/NZP-IM) resource configuration.
(12) whether to support an additional indication as to whether or not the CMRs are used for the hypothesis of at least one of NCJT measurement and STRP measurement.
(13) regarding two CMR groups for the L1 beam measurement/report or the CSI measurement/report, whether to support report of a bitmap for CMR pairing.
(14) whether to support different numbers of CMR resources regarding respective CMR groups for L1 beam measurement/report or CSI measurement/report.
(15) whether to support different numbers of CMR resources regarding NCJT/STRP measurement of respective CMR groups for L1 beam measurement/report or CSI measurement/report.
(16) at least one maximum value out of Ks, K1, K2, M1, M2, M, and V described above.

Note that each embodiment of the present disclosure may be applied under a condition of at least one of when the UE reports the UE capability corresponding to at least one of the above to the network and when the UE is configured/activated/indicated with the UE capability of at least one of the above by higher layer signaling. Each embodiment of the present disclosure may be applied when the UE is configured/activated/indicated with a specific higher layer parameter.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

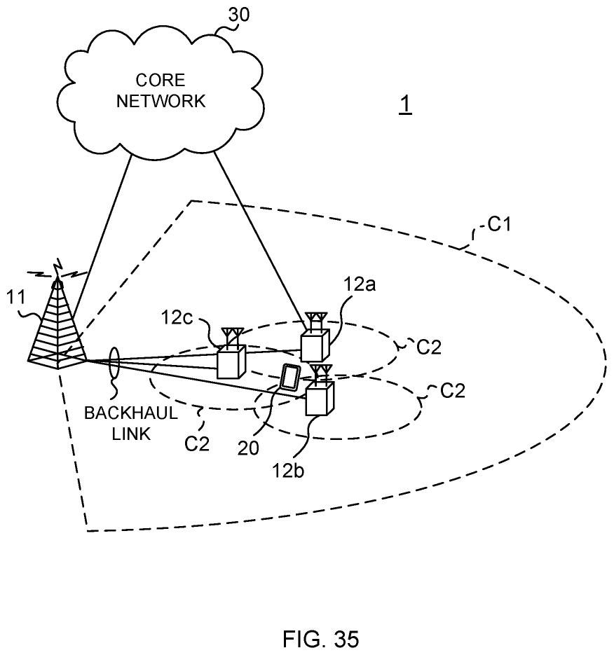

FIG. 35 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

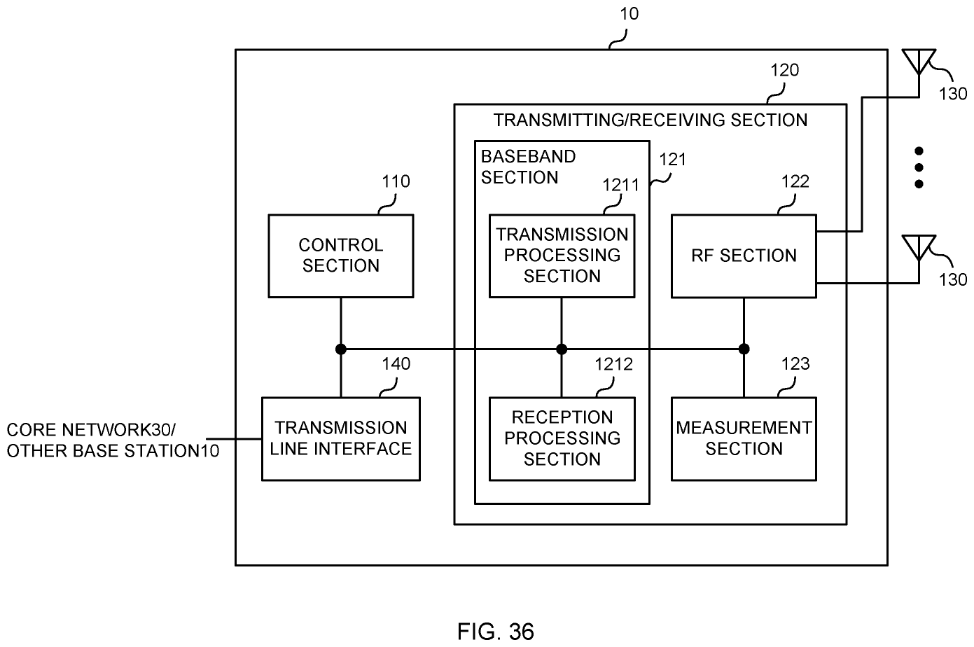

FIG. 36 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that, when the transmitting/receiving section 120 applies joint channel state information report, the transmitting/receiving section 120 may transmit configuration information corresponding to both of application of a resource for channel measurement for a plurality of transmission/reception points and application of a resource for channel measurement for a single transmission/reception point, and receive channel state information report transmitted based on the configuration information.

The transmitting/receiving section 120 may transmit the configuration information related to one or a plurality of pairs of the resource for channel measurement. The transmitting/receiving section 120 may receive group based beam report or channel state information report for the plurality of transmission/reception points transmitted based on the configuration information.

The transmitting/receiving section 120 may transmit, to the user terminal 20, configuration information regarding a resource for first channel measurement related to a resource group for first channel measurement (first CMR group) and a resource for second channel measurement related to a resource group for second channel measurement (second CMR group). The transmitting/receiving section 120 may receive a report of measurement performed by the user terminal 20 determining whether or not to use the resource for first channel measurement and the resource for second channel measurement for measurement for a plurality of transmission/reception points.

Note that these pieces of configuration information may be an RRC IE “CSI-ReportConfig” (or an IE included in the IE), or may be another RRC IE, for example.

### (User Terminal)

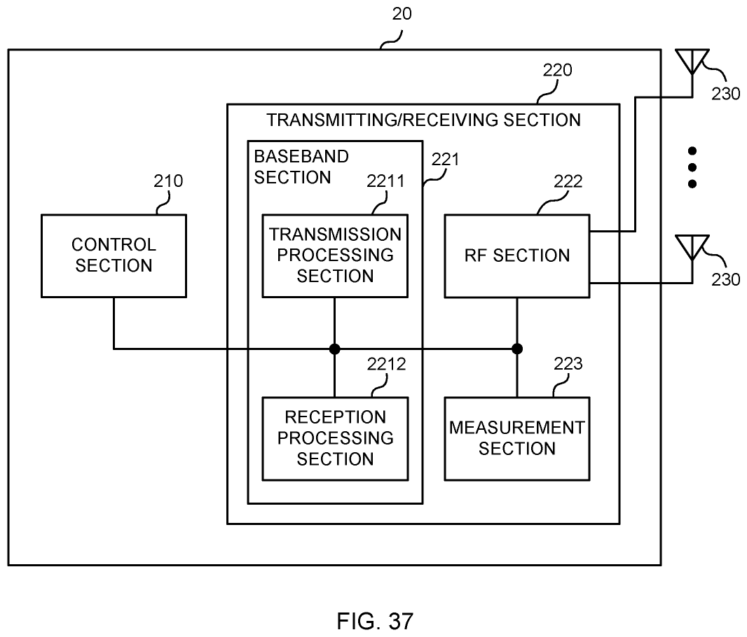

FIG. 37 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The control section 210 may determine a resource for first interference measurement corresponding to a first transmission/reception point or a resource for second interference measurement corresponding to a second transmission/reception point, based on at least one of a resource for first channel measurement corresponding to the first transmission/reception point and a resource for second channel measurement corresponding to the second transmission/reception point. When a specific higher layer parameter is configured, the control section 210 may determine the resource for first interference measurement of non-zero power, based on the resource for second channel measurement.

When the transmitting/receiving section 220 applies joint channel state information report, the transmitting/receiving section 220 may receive configuration information corresponding to both of application of a resource for channel measurement for a plurality of transmission/reception points and application of a resource for channel measurement for a single transmission/reception point.

The control section 210 may control transmission of channel state information report, based on the configuration information. The control section 210 may measure the resource for channel measurement measured as a channel state information pair for the plurality of transmission/reception points for the individual single transmission/reception point.

In the configuration information, the resource for channel measurement measured for the single transmission/reception point and the resource for channel measurement measured as the channel state information pair for the plurality of transmission/reception points may be configured independently of each other.

In the configuration information, a resource for interference measurement measured for the single transmission/reception point and a resource for interference measurement measured as the channel state information pair for the plurality of transmission/reception points may be configured independently of each other.

The transmitting/receiving section 220 may receive the configuration information related to one or a plurality of pairs (CMR pairs) of the resource for channel measurement (CMR). Note that the configuration information may be an RRC IE “CSI-ReportConfig” (or an IE included in the IE), or may be another RRC IE, for example.

The control section 210 may control the group based beam report or the channel state information report (or measurement related to these) for the plurality of transmission/reception points, based on the configuration information.

The control section 210 may assume that, regarding the plurality of pairs, the resource (or an ID) for channel measurement included in a certain pair (constituting the certain pair) is not included in another pair.

The control section 210 may assume that repetition is configured for each resource for channel measurement included in the plurality of pairs.

The control section 210 may assume that, regarding the plurality of pairs, a repetition period of one resource for channel measurement included in a certain pair and a repetition period of another resource for channel measurement included in the certain pair are different.

The transmitting/receiving section 220 may receive the configuration information regarding the resource for first channel measurement related to a resource group for first channel measurement (first CMR group) and the resource for second channel measurement related to a resource group for second channel measurement (second CMR group).

The control section 210 may determine whether or not to use the resource for first channel measurement and the resource for second channel measurement for measurement for the plurality of transmission/reception points.

The control section 210 may assume that a bitmap indicating a valid pair of the resource for first channel measurement and the resource for second channel measurement used for measurement for the plurality of transmission/reception points has a size based on number (M1) of the resources for first channel measurement and number (M2) of the resources for second channel measurement indicated by higher layer signaling (RRC/MAC CE).

It may be assumed that number of possible values (in other words, number of candidates) of a channel state information reference signal resource indicator used for report for the plurality of transmission/reception points is equal to number (V) of the valid pairs.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

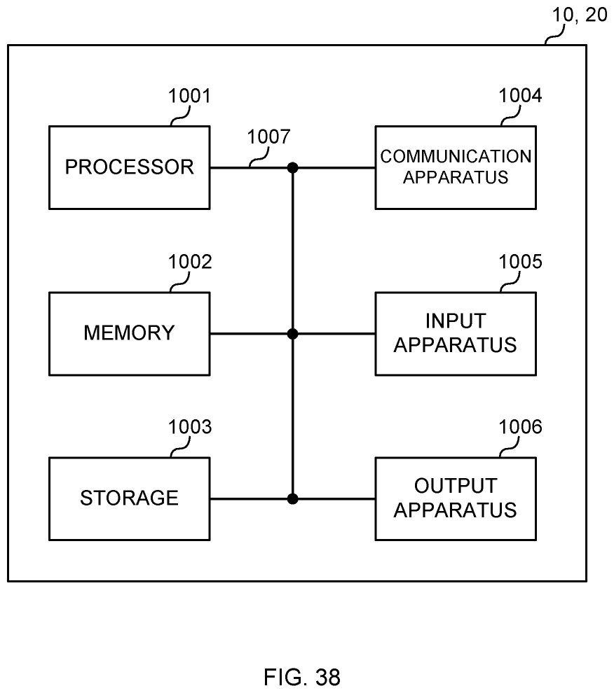

For example, a base station, a user terminal, and so on according to one embodiment of the present disclosure may function as a computer that executes the processes of the radio communication method of the present disclosure. FIG. 38 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (Iot) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

This application is based on Japanese Patent Application No. 2021-16811 filed on Feb. 4, 2021, the entire contents of which are incorporated herein by reference.

1.-5. (canceled)

6. A terminal comprising:
a receiver that receives information indicating, as a channel measurement resource (CMR) for a non-coherent joint transmission (NCJT) measurement, a first number of CMRs from a first CMR group and a second number of CMRs from a second CMR group; and
a processor that determines to use the first number of CMRs and the second number of CMRs for both the NCJT measurement and a single transmission/reception point (STRP) measurement.

7. The terminal according to claim 6, wherein the processor determines to use the first number of CMRs and the second number of CMRs for both the NCJT measurement and the STRP measurement in a certain frequency range, and determines to use the first number of CMRs and the second number of CMRs only for the NCJT measurement in a frequency range other than the certain frequency range.

8. A radio communication method for a terminal, comprising:
receiving information indicating, as a channel measurement resource (CMR) for a non-coherent joint transmission (NCJT) measurement, a first number of CMRs from a first CMR group and a second number of CMRs from a second CMR group; and
determining to use the first number of CMRs and the second number of CMRs for both the NCJT measurement and a single transmission/reception point (STRP) measurement.

9. A base station comprising:
a transmitter that transmits, to a terminal, information indicating, as a channel measurement resource (CMR) for a non-coherent joint transmission (NCJT) measurement, a first number of CMRs from a first CMR group and a second number of CMRs from a second CMR group; and
a receiver that receives a report of measurements, the measurements being performed by the terminal that determines to use the first number of CMRs and the second number of CMRs for both the NCJT measurement and a single transmission/reception point (STRP) measurement.

10. A system comprising a terminal and a base station, wherein
the terminal comprises:
a receiver that receives information indicating, as a channel measurement resource (CMR) for a non-coherent joint transmission (NCJT) measurement, a first number of CMRs from a first CMR group and a second number of CMRs from a second CMR group; and
a processor that determines to use the first number of CMRs and the second number of CMRs for both the NCJT measurement and a single transmission/reception point (STRP) measurement, and
the base station comprises:
a transmitter that transmits the information to the terminal.
